(19) United States
(12) Patent Application Publication
(10) Pub. No.: US 2026/0206055 A1
(43) Pub. Date: Jul. 16, 2026

(54) UNIFIED TRANSMISSION SEQUENCE FOR COORDINATED BEAMFORMING AND COORDINATED SPATIAL REUSE

(71) Applicant: QUALCOMM Incorporated, San Diego, CA (US)

(72) Inventors: Sherief HELWA, San Diego, CA (US); George CHERIAN, San Diego, CA (US); Abhishek Pramod PATIL, San Diego, CA (US); Ahmed Ragab ELSHERIF, San Jose, CA (US); Alfred ASTERJADHI, San Diego, CA (US); Gaurang NAIK, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 19/045,268

(22) Filed: Feb. 4, 2025

Related U.S. Application Data
(60) Provisional application No. 63/744,161, filed on Jan. 10, 2025.

(51) Int. Cl. H04W 74/0816; H04B 7/06; H04W 52/36

(52) U.S. Cl. CPC H04W 74/0816; H04B 7/0696; H04W 52/367

(57) ABSTRACT

This disclosure provides methods, devices, and systems for a unified frame transmission sequence for coordinated beamforming and coordinated spatial reuse. Some aspects more specifically relate to a first access point (AP) that transmits an invite frame within a shared transmission opportunity of the first AP. The invite frame may indicate initiation of a frame transmission sequence associated with a coordinated AP scheme of a plurality of coordinated AP schemes. The first AP and the second AP may communicate one or more frames within the shared transmission opportunity in accordance with the frame transmission sequence. The one or more frames may include information that coordinates downlink physical layer protocol data unit (PPDU) transmissions between the first AP and one or more second APs. In response to communicating the one or more frames, the first AP, a second AP, or both may transmit a coordinated downlink PPDU transmission.

### CROSS REFERENCE

The present Application for Patent claims the benefit of U.S. Provisional Patent Application No. 63/744,161 by HELWA et al., entitled “UNIFIED TRANSMISSION SEQUENCE FOR COORDINATED BEAMFORMING AND COORDINATED SPATIAL REUSE”, filed Jan. 10, 2025, which is assigned to the assignee hereof, and is expressly incorporated by reference herein.

### TECHNICAL FIELD

This disclosure relates generally to wireless communication and, more specifically, to unified transmission sequence for coordinated beamforming and coordinated spatial reuse.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first access point (AP). The method may include transmitting, within a shared transmission opportunity of the first AP, an invite frame that indicates initiation of a joint frame transmission sequence associated with a coordinated AP scheme of a set of multiple coordinated AP schemes, communicating, within the shared transmission opportunity of the first AP, a set of multiple frames in accordance with the frame transmission sequence, the set of multiple frames including information that coordinates downlink physical layer protocol data unit (PPDU) transmissions by the first AP and one or more second APs, and transmitting, within the shared transmission opportunity of the first AP and responsive to communication of the set of multiple frames, a coordinated downlink PPDU transmission.

Another innovative aspect of the subject matter described in this disclosure can be implemented in a first AP for wireless communication. The first AP may include a processing system that includes processor circuitry and memory circuitry that stores code. The processing system may be configured to cause the first AP to transmit, within a shared transmission opportunity of the first AP, an invite frame that indicates initiation of a joint frame transmission sequence associated with a coordinated AP scheme of a set of multiple coordinated AP schemes, communicate, within the shared transmission opportunity of the first AP, a set of multiple frames in accordance with the frame transmission sequence, the set of multiple frames including information that coordinates downlink physical layer protocol data unit (PPDU) transmissions by the first AP and one or more second APs, and transmit, within the shared transmission opportunity of the first AP and responsive to communication of the set of multiple frames, a coordinated downlink PPDU transmission.

Another innovative aspect of the subject matter described in this disclosure can be implemented in a first AP for wireless communication. The first AP may include means for transmitting, within a shared transmission opportunity of the first AP, an invite frame that indicates initiation of a joint frame transmission sequence associated with a coordinated AP scheme of a set of multiple coordinated AP schemes, means for communicating, within the shared transmission opportunity of the first AP, a set of multiple frames in accordance with the frame transmission sequence, the set of multiple frames including information that coordinates downlink PPDU transmissions by the first AP and one or more second APs, and means for transmitting, within the shared transmission opportunity of the first AP and responsive to communication of the set of multiple frames, a coordinated downlink PPDU transmission.

Another innovative aspect of the subject matter described in this disclosure can be implemented in a non-transitory computer-readable medium storing code for wireless communication. The code may include instructions executable by one or more processors to transmit, within a shared transmission opportunity of the first AP, an invite frame that indicates initiation of a joint frame transmission sequence associated with a coordinated AP scheme of a set of multiple coordinated AP schemes, communicate, within the shared transmission opportunity of the first AP, a set of multiple frames in accordance with the frame transmission sequence, the set of multiple frames including information that coordinates downlink PPDU transmissions by the first AP and one or more second APs, and transmit, within the shared transmission opportunity of the first AP and responsive to communication of the set of multiple frames, a coordinated downlink PPDU transmission.

In some examples of the method, first APs, and non-transitory computer-readable medium described herein, the set of multiple frames includes one or more initial control response frames, a response frame, a trigger frame, or any combination thereof.

In some examples of the method, first APs, and non-transitory computer-readable medium described herein, the invite frame includes an invitation to perform a CoBF operation between the first AP and a second AP of the one or more second APs.

In some examples of the method, first APs, and non-transitory computer-readable medium described herein, a first coordinated AP scheme of the set of multiple coordinated AP schemes includes a CoBF scheme and the invite frame includes an invitation to perform a CoBF operation between the first AP and a second AP of the one or more second APs, an indication of one or more wireless stations (STAs) associated with the first AP, or both.

In some examples of the method, first APs, and non-transitory computer-readable medium described herein, the invite frame includes a poll message of the CoBF scheme and requests a wireless station to perform frame exchange associated with the CoBF scheme.

In some examples of the method, first APs, and non-transitory computer-readable medium described herein, communicating the set of multiple frames in accordance with the joint frame transmission sequence may include operations, features, means, or instructions for transmitting an initial control frame including a poll message and a request to perform a frame exchange associated with the CoBF scheme.

In some examples of the method, first APs, and non-transitory computer-readable medium described herein, communicating the set of multiple frames in accordance with the frame transmission sequence may include operations, features, means, or instructions for receiving, from the wireless station and based on the poll message, a first initial control response frame that indicates availability of the wireless station to participate in frame exchange associated with the CoBF scheme.

In some examples of the method, first APs, and non-transitory computer-readable medium described herein, communicating the set of multiple frames in accordance with the joint frame transmission sequence may include operations, features, means, or instructions for receiving, from the second AP and based on the invitation, a second initial control response frame, a response frame, or both, where the second initial control response frame or the response frame indicate availability of the second AP to participate in frame exchange associated with the CoBF scheme.

In some examples of the method, first APs, and non-transitory computer-readable medium described herein, communicating the set of multiple frames in accordance with the joint frame transmission sequence may include operations, features, means, or instructions for receiving, from the second AP and based at least in part on the invitation, a response frame, wherein the response frame indicates availability of the second AP and an indication of an acceptance or rejection of the second AP to participate in a frame exchange associated with the CoBF scheme, indicates one or more wireless stations associated with the second AP, or both.

Some examples of the method, first APs, and non-transitory computer-readable medium described herein may further include operations, features, means, or instructions for preparing, based on the first initial control response frame, to participate in the frame exchange with the wireless station.

In some examples of the method, first APs, and non-transitory computer-readable medium described herein, communicating the set of multiple frames in accordance with the frame transmission sequence may include operations, features, means, or instructions for receiving, from the second AP and based on the invitation, a second initial control response frame, a response frame, or both, where the second initial control response frame and the response frame indicate availability of the second AP to participate in frame exchange associated with the CoBF scheme.

Some examples of the method, first APs, and non-transitory computer-readable medium described herein may further include operations, features, means, or instructions for preparing, based on the second initial control response frame, to participate in the frame exchange with the second AP.

In some examples of the method, first APs, and non-transitory computer-readable medium described herein, communicating the set of multiple frames in accordance with the frame transmission sequence may include operations, features, means, or instructions for transmitting, to the second AP, a trigger frame, where the trigger frame may be a frequency and time synchronization reference frame, and where the coordinated downlink PPDU transmission may be communicated in accordance with the frequency and time synchronization reference frame.

In some examples of the method, first APs, and non-transitory computer-readable medium described herein, the invite frame includes an invitation to perform a coordinated spatial reuse (CSR) operation between the first AP and a second AP of the one or more second APs and the invite frame includes an invitation to perform a CSR operation between the first AP and a second AP of the one or more second APs.

In some examples of the method, first APs, and non-transitory computer-readable medium described herein, a second coordinated AP scheme of the set of multiple coordinated AP schemes includes a CSR scheme.

In some examples of the method, first APs, and non-transitory computer-readable medium described herein, the invite frame includes a poll message of the CSR scheme and requests a wireless station to perform frame exchange associated with the CSR scheme and to transmit an initial coordinated response frame.

In some examples of the method, first APs, and non-transitory computer-readable medium described herein, and the method, apparatuses, and non-transitory computer-readable medium may include further operations, features, means, or instructions for transmitting an initial control frame including a poll message of the CSR scheme, and a request for a wireless STA to perform a frame exchange associated with the CSR scheme and to transmit an initial coordinated response frame.

In some examples of the method, first APs, and non-transitory computer-readable medium described herein, communicating the set of multiple frames in accordance with the frame transmission sequence may include operations, features, means, or instructions for receiving, from the wireless station and based on the poll message, a first initial control response frame that indicates availability of the wireless station to participate in frame exchange associated with the CSR scheme.

In some examples of the method, first APs, and non-transitory computer-readable medium described herein, communicating the set of multiple frames in accordance with the joint frame transmission sequence may include operations, features, means, or instructions for receiving, from the wireless STA and based on the poll message, an initial control response frame that indicates availability of the wireless STA to participate in the frame exchange associated with the CSR scheme.

Some examples of the method, first APs, and non-transitory computer-readable medium described herein may further include operations, features, means, or instructions for measuring, based on the first initial control response frame, a received signal power associated with the wireless station.

In some examples of the method, first APs, and non-transitory computer-readable medium described herein, communicating the set of multiple frames in accordance with the frame transmission sequence may include operations, features, means, or instructions for transmitting, to the second AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples of the method, first APs, and non-transitory computer-readable medium described herein, communicating the set of multiple frames in accordance with the frame transmission sequence may include operations, features, means, or instructions for receiving, from the second AP and based on the invitation, a response frame that indicates availability of the second AP to participate in frame exchange associated with the CSR scheme.

Another innovative aspect of the subject matter described in this disclosure can be implemented in a method for wireless communication by a second AP. The method may include receiving, within a shared transmission opportunity of a first AP, an invite frame that indicates initiation of a joint frame transmission sequence associated with a coordinated AP scheme of a set of multiple coordinated AP schemes, communicating, within the shared transmission opportunity, a set of multiple frames in accordance with the frame transmission sequence, the set of multiple frames including information that coordinates downlink PPDU transmissions by the first AP and the second AP, and transmitting, within the shared transmission opportunity and responsive to communication of the set of multiple frames, a coordinated downlink PPDU transmission.

Another innovative aspect of the subject matter described in this disclosure can be implemented in a second AP for wireless communication. The second AP may include a processing system that includes processor circuitry and memory circuitry that stores code. The processing system may be configured to cause the second AP to receive, within a shared transmission opportunity of a first AP, an invite frame that indicates initiation of a joint frame transmission sequence associated with a coordinated AP scheme of a set of multiple coordinated AP schemes, communicate, within the shared transmission opportunity, a set of multiple frames in accordance with the frame transmission sequence, the set of multiple frames including information that coordinates downlink PPDU transmissions by the first AP and the second AP, and transmit, within the shared transmission opportunity and responsive to communication of the set of multiple frames, a coordinated downlink PPDU transmission.

Another innovative aspect of the subject matter described in this disclosure can be implemented in another second AP for wireless communication. The second AP may include means for receiving, within a shared transmission opportunity of a first AP, an invite frame that indicates initiation of a joint frame transmission sequence associated with a coordinated AP scheme of a set of multiple coordinated AP schemes, means for communicating, within the shared transmission opportunity, a set of multiple frames in accordance with the frame transmission sequence, the set of multiple frames including information that coordinates downlink PPDU transmissions by the first AP and the second AP, and means for transmitting, within the shared transmission opportunity and responsive to communication of the set of multiple frames, a coordinated downlink PPDU transmission.

Another innovative aspect of the subject matter described in this disclosure can be implemented in a non-transitory computer-readable medium storing code for wireless communication. The code may include instructions executable by one or more processors to receive, within a shared transmission opportunity of a first AP, an invite frame that indicates initiation of a joint frame transmission sequence associated with a coordinated AP scheme of a set of multiple coordinated AP schemes, communicate, within the shared transmission opportunity, a set of multiple frames in accordance with the frame transmission sequence, the set of multiple frames including information that coordinates downlink PPDU transmissions by the first AP and the second AP, and transmit, within the shared transmission opportunity and responsive to communication of the set of multiple frames, a coordinated downlink PPDU transmission.

In some examples of the method, second APs, and non-transitory computer-readable medium described herein, the set of multiple frames includes an initial control response frame, a response frame, a trigger frame, or any combination thereof.

In some examples of the method, second APs, and non-transitory computer-readable medium described herein, the invite frame includes an invitation to perform a CoBF operation between the first AP and the second AP.

In some examples of the method, second APs, and non-transitory computer-readable medium described herein, a first coordinated AP scheme of the set of multiple coordinated AP schemes includes a CoBF scheme and the invite frame includes an invitation to perform a CoBF operation between the first AP and the second AP.

In some examples of the method, second APs, and non-transitory computer-readable medium described herein, communicating the set of multiple frames in accordance with the frame transmission sequence may include operations, features, means, or instructions for transmitting, to the first AP and based on the invitation, a first initial control response frame, a response frame, or both, where the first initial control response frame and the response frame indicate availability of the second AP to participate in frame exchange associated with the CoBF scheme.

In some examples of the method, second APs, and non-transitory computer-readable medium described herein, communicating the set of multiple frames in accordance with the joint frame transmission sequence may include operations, features, means, or instructions for transmitting an initial control frame including a poll message and requesting a wireless STA to perform a frame exchange associated with the CoBF scheme.

In some examples of the method, second APs, and non-transitory computer-readable medium described herein, communicating the set of multiple frames in accordance with the joint frame transmission sequence may include operations, features, means, or instructions for receiving, from a wireless STA and based on the initial control frame, an initial control response frame that indicates availability of the wireless STA to participate in the frame exchange associated with the CoBF scheme.

In some examples of the method, second APs, and non-transitory computer-readable medium described herein, communicating the set of multiple frames in accordance with the frame transmission sequence may include operations, features, means, or instructions for receiving, from a wireless station and based on the invitation, a second initial control response frame that indicates availability of the wireless station to participate in frame exchange associated with the CoBF scheme.

Some examples of the method, second APs, and non-transitory computer-readable medium described herein may further include operations, features, means, or instructions for preparing, based on the second initial control response frame, to participate in the frame exchange with the wireless station.

In some examples of the method, second APs, and non-transitory computer-readable medium described herein, communicating the set of multiple frames in accordance with the frame transmission sequence may include operations, features, means, or instructions for receiving, from the first AP, a trigger frame, where the trigger frame may be a frequency and time synchronization reference frame, and where the coordinated downlink PPDU transmission may be communicated in accordance with the frequency and time synchronization reference frame.

In some examples of the method, second APs, and non-transitory computer-readable medium described herein, the invite frame includes an invitation to perform a CSR operation between the first AP and the second AP.

In some examples of the method, second APs, and non-transitory computer-readable medium described herein, a second coordinated AP scheme of the set of multiple coordinated AP schemes includes a CSR scheme and the invite frame includes an invitation to perform a CSR operation between the first AP and the second AP.

In some examples of the method, second APs, and non-transitory computer-readable medium described herein, communicating the set of multiple frames in accordance with the frame transmission sequence may include operations, features, means, or instructions for transmitting, to the first AP and based on the invitation, a response frame that indicates availability of the second AP to participate in frame exchange associated with the CSR scheme.

In some examples of the method, second APs, and non-transitory computer-readable medium described herein, communicating the set of multiple frames in accordance with the joint frame transmission sequence may include operations, features, means, or instructions for transmitting an initial control frame including a poll message and requesting first a wireless STA associated with the second AP to perform a frame exchange associated with the CSR scheme.

Some examples of the method, second APs, and non-transitory computer-readable medium described herein may further include operations, features, means, or instructions for monitoring for an initial control response frame transmitted by a second wireless STA associated with the first AP, receiving, from the second wireless STA and based on the poll message, the initial control response frame that indicates availability of the wireless STA to participate in a frame exchange associated with the CSR scheme, and measuring, based on the initial control response frame, a received signal power associated with the second wireless STA.

Some examples of the method, second APs, and non-transitory computer-readable medium described herein may further include operations, features, means, or instructions for monitoring for an initial control response frame transmitted by a wireless station associated with the first AP and measuring, based on the initial control response frame, a received signal power associated with the wireless station.

In some examples of the method, second APs, and non-transitory computer-readable medium described herein, communicating the set of multiple frames in accordance with the frame transmission sequence may include operations, features, means, or instructions for receiving, from the first AP, a trigger frame that includes an indication of one or more of: a received signal power associated with a wireless station, a transmit power associated with transmission of the coordinated downlink PPDU transmission, an SIR threshold, a start time associated with transmission of the coordinated downlink PPDU transmission, an end time associated with transmission of the coordinated downlink PPDU transmission, or any combination thereof.

In some examples of the method, second APs, and non-transitory computer-readable medium described herein, adjusting, based on the trigger frame, a transmit power, where the coordinated downlink PPDU transmission may be transmitted based on the adjusted transmit power.

Another innovative aspect of the subject matter described in this disclosure can be implemented in a method for wireless communications by a wireless station. The method may include receiving, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmitting, within the shared transmission opportunity and based on the poll message, an initial control response frame, and receiving, within the shared transmission opportunity and based on transmission of the initial control response frame, a coordinated downlink PPDU transmission.

Another innovative aspect of the subject matter described in this disclosure can be implemented in a wireless station for wireless communications. The wireless station may include a processing system that includes processor circuitry and memory circuitry that stores code. The processing system may be configured to cause the wireless station to receive, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmit, within the shared transmission opportunity and based on the poll message, an initial control response frame, and receive, within the shared transmission opportunity and based on transmission of the initial control response frame, a coordinated downlink PPDU transmission.

Another innovative aspect of the subject matter described in this disclosure can be implemented in another wireless station for wireless communications. The wireless station may include means for receiving, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, means for transmitting, within the shared transmission opportunity and based on the poll message, an initial control response frame, and means for receiving, within the shared transmission opportunity and based on transmission of the initial control response frame, a coordinated downlink PPDU transmission.

Another innovative aspect of the subject matter described in this disclosure can be implemented in a non-transitory computer-readable medium storing code for wireless communications. The code may include instructions executable by one or more processors to receive, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmit, within the shared transmission opportunity and based on the poll message, an initial control response frame, and receive, within the shared transmission opportunity and based on transmission of the initial control response frame, a coordinated downlink PPDU transmission.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a wireless environment that supports techniques for a unified frame transmission sequence for coordinated beamforming (CoBF) and coordinated spatial reuse (CSR).

FIG. 3 shows an example of a frame transmission sequence associated with a CoBF scheme.

FIG. 4 shows an example of a frame transmission sequence associated with a CSR scheme.

FIG. 5 shows an example of a frame transmission sequence associated with an CSR scheme.

FIG. 6 shows an example of a unified frame transmission sequence that supports a unified frame transmission sequence for coordinated beamforming and coordinated spatial reuse.

FIG. 7 shows an example of a unified frame transmission sequence that supports a unified frame transmission sequence for coordinated beamforming and coordinated spatial reuse.

FIG. 8 shows a block diagram of an example wireless communication device that supports techniques for a unified frame transmission sequence for coordinated beamforming and coordinated spatial reuse.

FIG. 9 shows a block diagram of an example wireless communication device that supports techniques for a unified frame transmission sequence for coordinated beamforming and coordinated spatial reuse.

FIG. 10 shows a flowchart illustrating an example process performable by or at a first access point (AP) that supports techniques for a unified frame transmission sequence for coordinated beamforming and coordinated spatial reuse.

FIG. 11 shows a flowchart illustrating an example process performable by or at a second AP that supports techniques for a unified frame transmission sequence for coordinated beamforming and coordinated spatial reuse.

FIG. 12 shows a flowchart illustrating an example process performable by or at a wireless station that supports techniques for a unified frame transmission sequence for coordinated beamforming and coordinated spatial reuse.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support coordinated transmission messaging sequences in which two or more access points (APs) simultaneously use the medium (such as a wireless channel) in two or more basic service sets (BSSs) to transmit downlink communications to one or more wireless stations (STA) during a shared transmission opportunity. In some cases, the coordinated transmission messaging sequences may be associated with a particular coordinated AP scheme supported by the two or more APs. One example of a coordinated AP scheme may be a coordinated beamforming (CoBF) scheme. In this case, when the two or more APs operate in accordance with the CoBF scheme, a coordinated transmission messaging sequence may be associated with a CoBF operation. The CoBF operation may include a channel sounding phase, during which channel state information (CSI) is made available at each AP and a transmission phase, during which the APs coordinate to determine which stations (STAs) will be served and to synchronize transmissions in order to minimize interference. Another example of a coordinated AP scheme may be a coordinated spatial reuse (CSR) scheme. In this case, when the two or more APs operate in accordance with the CSR scheme, a coordinated transmission messaging sequence may be associated with a CSR operation. The CSR operation may involve a dynamic process in which the APs make real-time adjustments to transmit power, beamforming directions, or channel allocation to optimize spectrum reuse while minimizing interference. The APs may utilize the CoBF scheme or the CSR scheme to improve spectral efficiency, as well as capacity and performance at the network.

In some examples, to perform the coordinated transmission messaging sequences, the APs and one or more corresponding wireless STAs served by the APs may exchange one or more frames, such as one or more invite frames, initial control frames (ICFs), initial control responses (ICRs) frames, response frames, trigger or synchronization frames, acknowledgement frames, or any combination thereof to prepare the one or more STAs to receive data. In some cases, however, the sequence of the frame transmission may differ depending on which coordinated AP scheme the APs operate in accordance with.

Various aspects relate generally to techniques for providing a generic or unified frame transmission sequence that may be utilized to support different coordinated AP schemes, such as the CoBF scheme and the CSR scheme. In this way, a single unified frame transmission sequence may be provided to replace multiple distinct frame transmission sequences conventionally used to support different coordinated AP schemes. Some aspects more specifically relate to the particular sequence of transmission of the frames within the frame transmission sequence and the content of such frames in the example of the different coordinated AP schemes. Although aspects herein may describe the concepts and techniques in the context of CoBF and CSR schemes, it should be understood that these concepts and techniques may apply to any type of coordinated AP scheme, and are not limited to CoBF and CSR schemes.

In some examples, a first AP, such as a sharing AP, may identify an opportunity during which the first AP and one or more second APs, such as a shared AP, may simultaneously transmit downlink communications to the respective wireless STAs using different spatial resources. The first AP may announce the shared transmission opportunity by transmitting an invite frame during the shared transmission opportunity. The invite frame may indicate the initiation of a frame transmission sequence associated with a coordinated AP scheme of a plurality of coordinated AP schemes. The plurality of coordinated AP schemes may include at least a first coordinated AP scheme and a second coordinated AP scheme. For instance, the invite frame may include an invitation to perform a CoBF operation or a CSR operation between the first AP and the second AP. In some examples, the invite frame may include a poll message that requests a wireless STA to perform frame exchange associated with the first coordinated AP scheme or the second coordinated AP scheme. In response to the invitation, the first AP and the second AP may communicate, during the shared transmission opportunity, a plurality of frames in accordance with the frame transmission sequence. The plurality of frames may include information that coordinates downlink physical layer protocol data unit (PPDU) transmissions by the first AP and a second AP. In some examples, based on the poll message included in the invite frame, the wireless STA may transmit an ICR frame that indicates availability of the wireless STA to participate in frame exchange in accordance with a coordinated AP scheme indicated by the invite frame. The first AP and the second AP may thereafter transmit to their respective wireless STAs, during the shared transmission opportunity, one or more coordinated downlink PPDU transmissions.

Particular aspects of the subject matter described in this disclosure may be implemented to realize one or more of the following potential benefits. In some examples, the described techniques may simplify and reduce a quantity of distinct frame transmission sequences necessary to support multiple coordinated AP schemes used to for coordinated transmissions during a shared transmission opportunity between two or more APs. For instance, the described techniques may replace multiple distinct frame transmission sequences conventionally used to support different coordinated AP schemes, with a single unified frame transmission sequence. A single unified frame transmission sequence may reduce complexity in hardware implementation at one or more APs and one or more wireless stations, by eliminating the requirement to support multiple coordinated AP schemes. Accordingly, by a first AP inviting one or more second APs to participate in a frame exchange using the unified frame transmission sequence that is associated with multiple coordinated AP schemes, and by communicating in accordance with the unified frame transmission sequence, improvements in communication between devices at a network may be realized, which may result in an improvement to performance at the network.

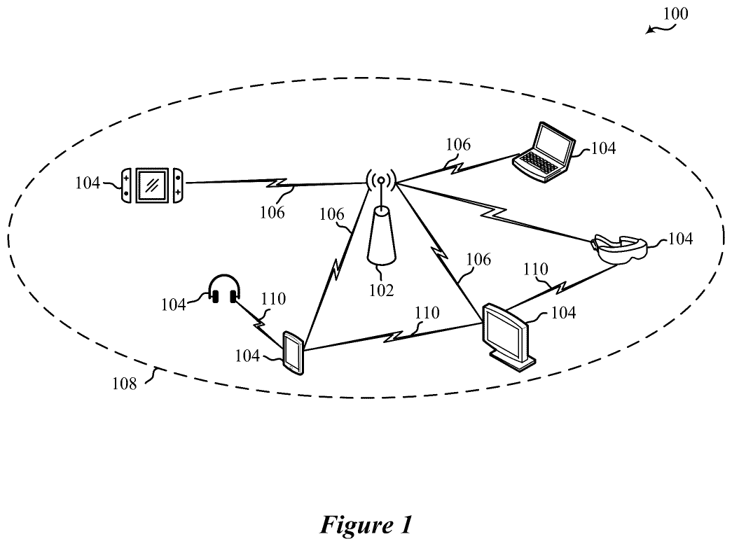

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in OBSSs. The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

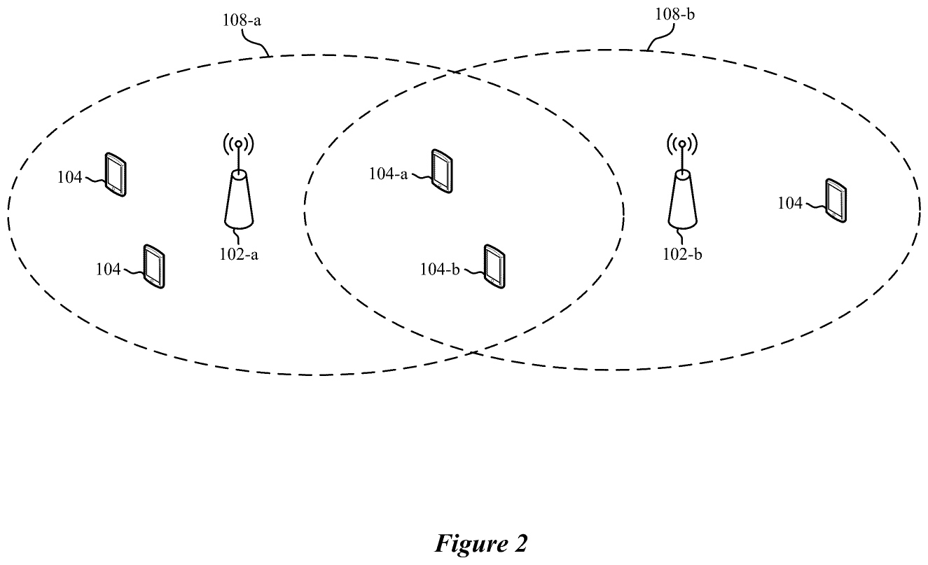

FIG. 2 shows an example of a wireless environment 200 that supports techniques for a unified frame transmission sequence for CoBF and CSR. In some examples, the wireless environment 200 may implement or be implemented by aspects of the wireless communication network 100. For example, the wireless environment 200 may include a first AP 102-a, a second AP 102-b, a first wireless STA 104-a, a second wireless STA 104-b, and one or more other wireless STAs 104, which may be examples of corresponding devices described herein with reference to FIG. 1. Additionally, or alternatively, the APs 102 and the wireless STAs 104 may each be examples of other types of wireless devices, such as a BS, a UE, or another type of transmitter or receiver. Thus, although aspects of the present disclosure are described with reference to APs 102 and wireless STAs 104, it is understood that the described techniques may be performed by a wireless device different from an AP 102 and a wireless STA 104. As described herein, operations performed by the APs 102 and the wireless STAs 104 may be respectively performed by an AP 102, a wireless STA 104, or another wireless device, and the examples shown should not be construed as limiting. Additionally, or alternatively, while two APs 102 and five wireless STAs 104 are shown in the wireless environment 200, more devices or fewer devices may be possible and the examples shown should not be construed as limiting.

Each of the first AP 102-a and the second AP 102-b may be associated with a respective BSS (such as a first BSS and a second BSS, respectively), where each BSS includes one or more wireless STAs 104. For example, the first BSS may include one or more devices within a first coverage area 108-a (such as the AP 102-a, the wireless STA 104-a, the wireless STA 104-b, and one or more other wireless STAs 104). Similarly, the second BSS may include one or more devices within a second coverage area 108-b (such as the AP 102-b, the wireless STA 104-a, the wireless STA 104-b, and one or more other wireless STAs 104). The wireless STAs 104 may be connected to the first AP 102-a, the second AP 102-b, or both via a communication link 106. In some examples, the first BSS and the second BSS may be overlapping to form an OBSS. For example, the wireless STA 104-a and the wireless STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

In some examples, devices in the wireless environment 200 may support one or more coordinated AP schemes, such as a CSR scheme and a CoBF scheme. The CSR scheme may support one or more CSR operations and the CoBF scheme may support one or more CoBF operations. Both the CSR and the CoBF operations may aim to simultaneously use a medium (such as a wireless channel) in two or more BSSs to maximize the system throughput. The CSR operations may involve a dynamic process in which the APs 102 may make real-time adjustments to transmit power, beamforming directions, channel allocation, or any combination thereof. The CoBF operations may involve a channel sounding phase, during which CSI is made available at each of the AP 102 and a transmission phase, during which the APs 102 coordinate to determine which wireless STAs 104 will be served and to synchronize transmissions in order to minimize interference. The CSR operations may involve a pre-transmission phase for interference estimation and transmit power calculation to manage, reduce, or limit the interference imposed by an AP onto an OBSS STA.

In some examples, the CoBF operation may exploit one or more hardware capabilities of the AP 102-a and the AP 102-b (such as larger antenna arrays) to actively null signals at one or more clients of the OBSS using transmission beamforming. For example, the first AP 102-a may create a null at the second wireless STA 104-b associated with the second AP 102-b and the second BSS, and the second AP 102-b may create a null at the first wireless STA 104-a associated with the first AP 102-a and the first BSS. In this way, OBSS interference may be limited and successful reception may be achieved. However, to perform such a CoBF operation, transmitting devices (such as the first AP 102-a and the second AP 102-b) may have CSI knowledge (such as may know CSI information). For example, the AP 102-a may perform the CoBF operation based on knowing the channel estimate between the AP 102-a and an associated client (such as wireless STA 104) as well as between the AP 102-a and the OBSS client (such as the wireless STA 104-a). The AP 102-a may be unable to perform the CoBF operation without such channel estimates.

A CoBF operation may be divided into two main phases: a channel sounding phase (such as CSI estimate collection) and a transmission phase (such as initial negotiation and initial handshaking between the first AP 102-a and the second AP 102-b in addition to data transmission). The objective of the channel sounding phase may be to make the CSI available at the OBSS APs 102 so that the OBSS AP 102 may actively null a signal at the OBSS client. For example, as a result of the channel sounding phase, the first AP 102-a may null an associated signal at the wireless STA 104-b and the second AP 102-b may null an associated signal at the wireless STA 104-a to reduce interference. During the transmission phase of the CoBF operation, the first AP 102-a and the second AP 102-b (and any other APs 102 that may contribute to the OBSS) may agree on which clients (such as wireless STAs 104) will be served by which AP 102, synchronize with each device, and proceed with simultaneous data transmission. During the simultaneous data transmission, the first AP 102-a and the second AP 102-b may use the CSI collected during the channel sounding phase in order to create the nulls in each respective signal.

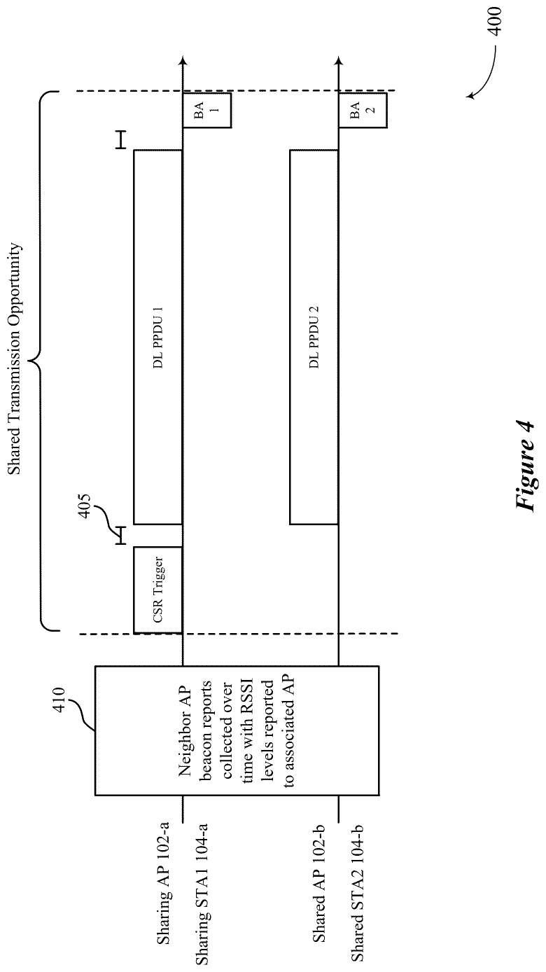

The channel sounding phase of the CoBF operation may be a collaborative process performed by two or more APs 102 to collect CSI between each AP 102 and the OBSS clients (such as wireless STAs 104). The general procedures of CoBF channel sounding may follow the same concept of legacy in-BSS CoBF channel sounding using the NDPA-NDP-BFRP-CSI frame sequence, as illustrated by at least FIG. 4.

CoBF channel sounding may be sequential or joint. In sequential channel sounding, sounding is first performed for an associated AP 102 (such as the first AP 102-a) by transmitting a null data packet (NDP) and receiving CSI in response to a beamforming report (BFRP) frame. Second sounding is performed for an OBSS AP 102 (such as the second AP 102-b). For example, the associated AP (such as the first AP 102-a) may transmit a null data packet announcement (NDPA) on behalf of the OBSS AP (such as second AP 102-b). The OBSS AP (such as the second AP 102-b) may transmit an NDP followed by a BFRP frame sent by the associated AP (such as the first AP 102-a) on behalf of the OBSS AP (such as the second AP 102-b). Finally, the client (such as the AP 102) may report back associated CSI. The sequential sounding process may be repeated for all APs 102 participating in the channel sounding process.

Joint channel sounding, in contrast, may aim to perform the sounding process in a more efficient way by performing CSI estimation to the associated AP (such as the first AP 102-a) as well as the OBSS AP (such as the second AP 102-b) simultaneously. A similar sounding sequence to that of sequential sounding may be used, but with the following differences. In joint channel sounding, one or more NDP frames may be sent jointly by both APs 102 at the same time. In such cases, CSI estimation to the two APs 102 can be done using a separate set of LTFs. Joint channel sounding may save up to three frame exchanges per AP 102 compared to sequential channel sounding, which may reduce the overhead of the sounding sequence.

During the transmission phase of the CoBF operation, the two or more APs 102 may agree on which clients (such as wireless STAs 104) will be served by each AP 102 during a shared transmission opportunity and whether or not each AP 102 can null an associated transmission signal at the one or more clients of the other AP 102. Such an agreement may be achieved by means of the following three-way handshaking sequence. First, the first AP 102-a (such as a sharing AP) may share common preamble information in addition to which client (such as the first wireless STA 104-a) or clients the first AP 102-a may serve via a CoBF invite frame (such as the CoBF invite frame may be associated with triggering one or more wireless STAs 104 to transition from a first operating state to a second operating state). The sharing AP may own the shared transmission opportunity. For example, in order to generate a common portion of later downlink PPDUs (such as CoBF messaging) at the first AP 102-a and the second AP 102-b with at least a portion of the file headers in common, the APs 102 may agree on one or more parameters. Second, the second AP 102-b (such as a shared AP) may acknowledge that the second AP 102-b can null an associated signal at the first AP 102-a client (such as the first wireless STA 104-a) and may declare which client the second AP 102-b will serve (such as the second wireless STA 104-b) via a CoBF response frame (such as based on the CoBF invite frame). The shared AP may use the shared transmission opportunity. Third, the first AP 102-a may acknowledge that the second AP 102-b can null an associated signal at the second AP 102-b client (such as the second wireless STA 104-b) via an ACK/Sync frame. The ACK/Sync frame may be used for synchronizing data transmissions, sharing information for creating a common preamble for downlink PPDUs, or both.

In some examples, one or more of the wireless STAs 104 may be an enhanced multi-link single radio (eMLSR) wireless STA, may be in a CoEx mode, may be in a dynamic-power saving (DPS) mode, or any combination thereof. In such examples, the one or more wireless STAs 104 may exchange one or more ICFs and one or more ICR frames with an in-BSS AP 102 to prepare for a coordinated transmission messaging sequence, such as a channel sounding sequence, a transmission sequence, or both of a CoBF operation. For example, the channel sounding phase of the CoBF operation (which may be a sequential sounding operation or a joint sounding operation) may include two or more channel sounding sequences. During each channel sounding sequence of the channel sounding phase of the CoBF operation, an AP 102 may transmit one or more ICFs to one or more wireless STAs 104 requesting the one or more wireless STAs 104 to prepare to receive one or more frames as part of the channel sounding sequence. The one or more wireless STAs 104 may respond to the one or more ICFs with one or more ICRs acknowledging the ICF, indicating unavailability information, indicating that the one or more wireless STAs 104 are prepared to receive the one or more frames as part of the channel sounding sequence, or a combination thereof. As a result of the channel sounding phase, each AP 102 in the OBSS may have CSI associated with each of the one or more wireless STAs 104, which may be used to determine which clients will be served by which AP 102. During the transmission phase of the CoBF operation, an ICF/ICR exchange may take place between each AP 102 and one or more associated wireless STAs 104 to prepare the one or more associated wireless STAs 104 for reception of a downlink PPDU.

In some examples, however, the sequence of the frame transmission may differ depending on which coordinated AP scheme the APs 102 operate in accordance with. In accordance with aspects described herein, to simplify and reduce a quantity of frame sequences used to support different coordinated AP schemes, a single generic or unified frame transmission sequence may be utilized. The frame transmission sequence may be a generic or unified frame transmission sequence that supports different coordinated AP schemes, such as the CoBF scheme and the CSR scheme.

For instance, the first AP 102-a may be a sharing AP that identifies an opportunity during which the first AP 102-a and the second AP 102-b (such as a shared AP) may simultaneously transmit downlink communications to the respective wireless STAs 104 using different spatial resources. The first AP 102-a may announce the shared transmission opportunity by transmitting an invite frame during the shared transmission opportunity. The invite frame may indicate the initiation of a frame transmission sequence associated with a coordinated AP scheme of a plurality of coordinated AP schemes. The plurality of coordinated AP schemes may include at least a first coordinated AP scheme (such as a CoBF scheme) and a second coordinated AP scheme (such as a CSR scheme). For instance, the invite frame may include an invitation to perform a CoBF or a CSR operation between the first AP 102-a and the second AP 102-b. In some examples, the invite frame may include a poll message that requests a wireless STA 104 to perform frame exchange associated with the first coordinated AP scheme or the second coordinated AP scheme. In response to the invitation, the first AP 102-a and the second AP 102-b may communicate, during the shared transmission opportunity, a plurality of frames in accordance with the frame transmission sequence. The plurality of frames may include information that coordinates downlink PPDU transmissions by the first AP 102-a and the second AP 102-b. In some examples, based on the poll message included in the invite frame, the wireless STA 104 may transmit an ICR frame that indicates availability of the wireless STA 104 to participate in frame exchange in accordance with the coordinated AP scheme indicated by the invite frame. The first AP 102-a and the second AP 102-b may thereafter transmit to their respective wireless STAs 104, during the shared transmission opportunity, one or more coordinated downlink PPDU transmissions.

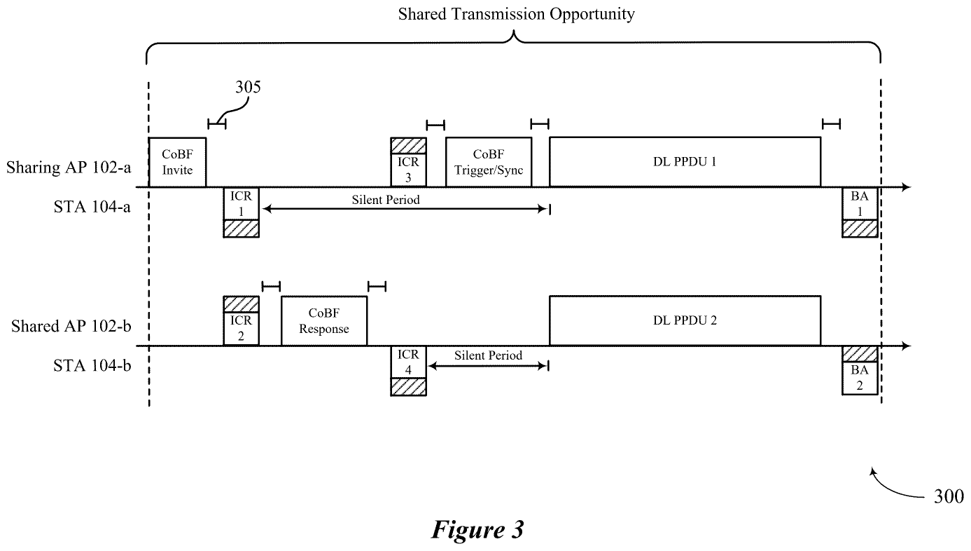

FIG. 3 shows an example of a frame transmission sequence 300 associated with a CoBF scheme. In some examples, the frame transmission sequence 300 may implement or be implemented by aspects of the wireless communication network 100 or the wireless environment 200 described with reference to FIGS. 1 and 2. For example, the frame transmission sequence 300 may include a CoBF invite frame, one or more ICR frames, a CoBF response frame, a CoBF trigger/synchronization frame, one or more block acknowledgement (BA) frames, and one or more downlink PPDUs. The various frames and transmissions may be separated by one or more gaps 305 or silent periods. The frame transmission sequence 300 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 and 2. The sharing AP 102-a may identify one or more shared transmission opportunities during which the sharing AP 102-a and the shared AP(s) 102-b may simultaneously transmit communications to the wireless STA(s) 104-a and wireless STA(s) 104-b, respectively.

In some implementations, the sharing AP 102-a and the shared AP 102-b may support the CoBF scheme. In such cases, the sharing AP 102-a and the shared AP 102-b may operate in accordance with one or more CoBF operations. The CoBF operations may involve one or more phases. During a transmission phase of the CoBF operation, the sharing AP 102-a and the shared AP 102-b may confirm their preparedness to participate in the shared transmission opportunity. The sharing AP 102-a and the shared AP 102-b may notify each other about which clients, such as which wireless STAs 104 will be scheduled. This may be achieved through the communication of a set of frames between the sharing AP 102-a, the shared AP 102-b, and one or more wireless STAs 104.

For instance, the sharing AP 102-a may transmit a CoBF invite frame during the shared transmission opportunity. The CoBF invite frame may include an invitation that requests participation of the shared AP 102-b in a frame exchange during the shared transmission opportunity. The CoBF invite frame may include an indication of which wireless STAs 104 will be served by the sharing AP 102-a. In some examples, the CoBF invite frame may include a poll message. The poll message may cause a wireless STA 104 associated with the sharing AP 102-a, such as the first wireless STA 104-a, to be polled to provide an indication of the availability of the first wireless STA 104-a. The CoBF invite frame may further provide padding for link activation (such as for eMLSR) or switching to high capability mode (such as DPS). In some examples, this may be achieved by embedding an ICF into the CoBF invite frame, by aggregating the ICF frame with the CoBF invite frame, or by making them one multi-purpose frame. In some examples, the poll message included in the CoBF invite may cause the shared AP 102-b to be polled to provide an indication of the availability of the shared AP 102-b and ensure that the shared AP 102-b is prepared to participate in the frame exchange.

In response to the CoBF invite frame, a CoBF Response may be transmitted by the shared AP 102-b, the wireless STA 104-b, or both. For example, the shared AP 102-b may transmit an ICR frame or a CoBF response frame that confirms the availability of the shared AP 102-b to participate in the frame exchange during the shared transmission opportunity. The ICR frame or the CoBF response frame may further include an indication of which STAs will be served by the AP 102-a. In some examples, the ICR or CoBF response frames may include a poll message that causes a STA 104 associated with the shared AP 102-b, such as the second wireless STA 104-b, to be polled to provide an indication of an availability of the second wireless STA 104-b to participate in the frame exchange. In some examples, the ICR or CoBF frame may further provide padding for link activation (such as for eMLSR) or switching to high capability mode (such as DPS). In some examples, this may be achieved by embedding an ICF into the CoBF invite frame, by aggregating the ICF frame with the CoBF invite frame, or by making them one multi-purpose frame. In some examples, the poll message included in the CoBF invite may cause the shared AP 102-b to be polled to provide an indication of an availability of the shared AP 102-b and to ensure that the shared AP 102-b is prepared to participate in the frame exchange.

The sharing AP 102-a may transmit a CoBF trigger/synchronization frame. The CoBF trigger/synchronization frame may be a frequency and time synchronization reference signal for the shared AP 102-b to use to coordinate a downlink PPDU transmission. In some examples, the CoBF trigger/synchronization frame may include information for generating a common preamble.

The sharing AP 102-a and the shared AP 102-b may transmit, during the shared transmission opportunity of the sharing AP 102-a, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

FIG. 4 shows an example of a frame transmission sequence 400 associated with a CSR scheme. In some examples, the frame transmission sequence 400 may implement or be implemented by aspects of the wireless communication network 100 or the wireless environment 200 described with reference to FIGS. 1 and 2. For example, the frame transmission sequence 400 may include a CSR trigger frame, one or more BA frames, and one or more downlink PPDUs. The various frames and transmissions may be separated by one or more gaps 405. The frame transmission sequence 400 may be implemented by a sharing AP 102-a, a shared AP 102-b, a first wireless STA 104-a, a second wireless STA 104-b, or a combination thereof which may be examples of corresponding devices described herein with reference to FIGS. 1 and 2. The sharing AP 102-a may identify one or more shared transmission opportunities during which the sharing AP 102-a and the shared AP 102-b may simultaneously transmit communications to the wireless STA 104-a and wireless STA 104-b, respectively.

In some implementations, the sharing AP 102-a and the shared AP 102-b may support the CSR scheme. In such cases, the sharing AP 102-a and the shared AP 102-b may operate in accordance with one or more CSR operations. In some cases, there may be different variants of frame transmission sequences associated with the CSR scheme. In some cases, the different variants may differ with respect to how the sharing AP 102-a and the shared AP(s) 102-b estimate interference that the shared AP(s) 102-b may cause to the scheduled first wireless STA 104-a of the sharing AP 102-a, and how such interference may be controlled using an adjustment to transmit power at the shared AP(s) 102-b or by other means, such as STAs 104 scheduling where STAs 104 that are known to be more susceptible to interference are not scheduled during shared transmission opportunities.

In the example of a first variant, offline interference estimation 410 may be performed. In this implementation, interference estimation may be performed offline in the background by collecting RSSI reports (such as beacon reports including RSSI information) from associated wireless STAs 104 including RSSI information measured with respect to neighbor APs 102. The sharing AP 102-a may utilize the RSSI reports to estimate interference levels caused by neighbor APs 102 on its associated wireless STA 104. Each of the APs 102 may store an interference estimate value for each of its associated wireless STAs 104 per OBSS. Based on the estimates, the sharing AP 102-a may decide which other APs 102 to poll to share the shared transmission opportunity and how much transmit power backoff apply to minimize interference during the shared transmission opportunity. The sharing AP 102-a may signal, via the CSR trigger frame, the offline interference estimation 410 and the transmit power backoff amount to the shared AP 102-b.

The sharing AP 102-a and the shared AP 102-b may transmit, during the shared transmission opportunity of the first AP, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

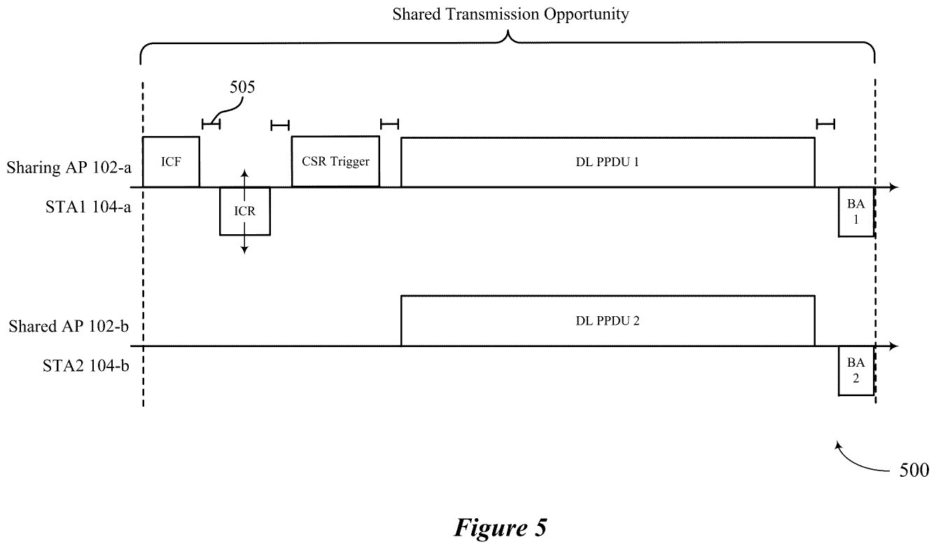

FIG. 5 shows an example of a frame transmission sequence 500 associated with a CSR scheme. In some examples, the frame transmission sequence 500 may implement or be implemented by aspects of the wireless communication network 100 or the wireless environment 200 described with reference to FIGS. 1 and 2. For example, the frame transmission sequence 500 may include an ICF frame, an ICR frame, a CSR trigger frame, one or more BA frames, and one or more downlink PPDUs. The various frames and transmissions may be separated by one or more gaps 505. The frame transmission sequence 500 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 and 2. The sharing AP 102-a may identify one or more shared transmission opportunities during which the sharing AP 102-a and the shared AP 102-b may simultaneously transmit communications to the wireless STA 104-a and wireless STA 104-b, respectively.

In some implementations, the sharing AP 102-a and the shared AP 102-b may support the CSR scheme. In such cases, the sharing AP 102-a and the shared AP 102-b may operate in accordance with one or more CSR operations. In some cases, there may be different variants of frame transmission sequences associated with the CSR scheme. In some cases, the different variants may differ with respect to how the sharing AP 102-a and the shared AP 102-b estimate interference that the shared AP 102-b may cause to the scheduled first wireless STA 104-a of the sharing AP 102-a, and how such interference may be controlled using an adjustment to transmit power at the shared AP 102-b.

In the example of a second variant, dynamic interference estimation may be performed. In this implementation, interference estimation may be performed, within the shared transmission opportunity, by the sharing AP 102-a and the one or more shared APs 102-b dynamically based on received power measurements associated with an ICR frame sent by a scheduled wireless STA 104, such as the first wireless STA 104-a, of the sharing AP 102-a.

The sharing AP 102-a may measure received power (R₁) associated with the ICR transmitted by the first wireless STA 104-a. The sharing AP 102-a may transmit, to the shared AP 102-b, via the CRS trigger frame, an indication of the measured received power (R₁). The sharing AP 102-a may additionally transmit, to the shared AP 102-b, via the CSR trigger frame, an indication of one or more other CSR operational parameters, such as a threshold (such as a minimum) signal to interference ratio (SIR) accepted at the first wireless STA 104-a, a transmit power (T₁) associated with the sharing AP 102-a and used for transmission of a first DL PPDU 1. In some examples, the CSR trigger frame may include padding.

The shared AP 102-b may receive the CSR trigger frame and may use the measured received power to perform link-budget calculations to estimate the maximum allowable transmit power for the shared AP 102-b to transmit one or more coordinated downlink PPDU transmissions. In some examples, the shared AP 102-b also may monitor for the ICR transmitted by the first wireless STA 104-a and may itself measure the received power (R₂) associated with the ICR. The shared AP 102-b may calculate a threshold (such as maximum) transmit power (T₂) associated with the shared AP 102-b, where T₂=(T₁−SIR)+R₁−R₂).

The sharing AP 102-a and the shared AP 102-b may transmit, during the shared transmission opportunity of the first AP, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

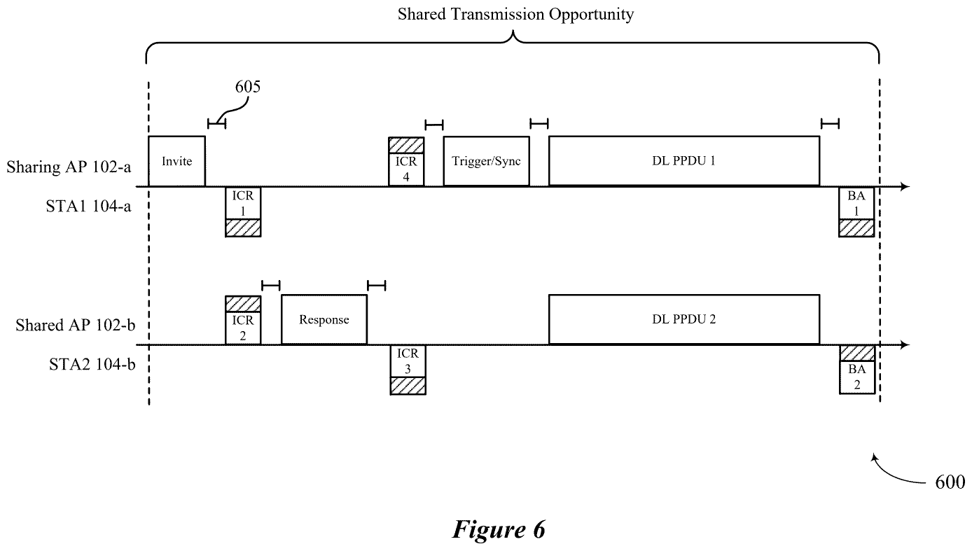

FIG. 6 shows an example of a unified frame transmission sequence 600 that supports techniques for a unified frame transmission sequence for CoBF and CSR. In some examples, the unified frame transmission sequence 600 may implement or be implemented by aspects of the wireless communication network 100, the wireless environment 200, the frame transmission sequences 300, 400, and 500 described with reference to FIGS. 1-5. For example, the unified frame transmission sequence 600 may include an invite frame, one or more ICR frames, a response frame, a trigger/synchronization frame, one or more BA frames, and one or more downlink PPDUs. The various frames and transmissions may be separated by one or more gaps 605. The unified frame transmission sequence 600 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 through 5. The sharing AP 102-a may identify one or more shared transmission opportunities during which the sharing AP 102-a and the one or more shared APs 102-b may simultaneously transmit communications to the wireless STA 104-a and wireless STA 104-b, respectively.

In accordance with aspects described herein, a frame transmission sequence associated with the CoBF scheme (such as frame transmission sequence 300) and a second variant frame transmission sequence associated with the CSR scheme (such as frame transmission sequence 500) may be unified into a common frame transmission sequence, such as the unified frame transmission sequence 600. In some examples, the second variant frame transmission sequence associated with the CSR scheme may be a subset of the frame transmission sequence associated with a CoBF scheme. In the unified frame transmission sequence 600, the various frames may carry different information depending on which of the coordinated AP schemes the sharing AP 102-a and the sharing AP 102-a operate in accordance with.

For instance, the sharing AP 102-a may transmit an invite frame, and the shared AP 102-b may receive, during a shared transmission opportunity, the invite frame. The invite frame may indicate that the shared AP 102-b (and one or more wireless STAs 104) should operate in accordance with the unified frame transmission sequence 600, where the frame transmission sequence is associated with a first coordinated AP scheme, such as the CoBF AP scheme, or a second coordinated AP scheme, such as the CSR AP scheme. For example, the invite frame may indicate which of the first coordinated AP scheme or the second coordinated AP scheme the sharing AP 102-a and the shared AP 102-b should operate in accordance with.

When the sharing AP 102-a and the shared AP 102-b operate in accordance with the CoBF scheme, the invite frame may include an invitation to the shared AP 102-b to perform a CoBF operation (such as to participate in the frame exchange in accordance with the CoBF scheme) and may additionally include information associated with one or more wireless STAs 104 scheduled by the sharing AP 102-a, such as the first wireless STA 104-a. In some instances, the invite frame may act as an ICF to poll the one or more first wireless STAs 104-a and prepare the one or more first wireless STAs 104-a for further frame exchanges. For example, the invite frame may include a poll message that causes the one or more first wireless STAs 104-a to be polled. In some instances, the poll message included in the invite frame may additionally poll the shared AP 102-b to determine an availability of the shared AP 102-b for a frame exchange in accordance with the CoBF scheme.

When the sharing AP 102-a and the shared AP 102-b operate in accordance with the CSR scheme, the invite frame may include an invitation to one or more shared APs 102-b to perform a CSR operation (such as to participate in the frame exchange in accordance with the CRS scheme) and may additionally act as an ICF to poll the first wireless STA 104-a to respond with an ICR indicating availability of the first wireless STA 104-a for the frame exchange in accordance with the CSR scheme. In some examples, the invite may include padding. In the case of the CSR scheme, the invite frame may not be enabled to poll a response frame from the shared AP 102-b because the shared AP 102-b may be engaged in monitoring for an ICR (such as a first ICR1) transmitted by the first wireless STA 104-a in order to measure its received power.

After sending the invite frame, the sharing AP 102-a and the shared AP 102-b may communicate a plurality of frames within the shared transmission opportunity and in accordance with the frame transmission sequence. For instance, in response to the invitation to participate in the frame exchange, one or more ICR frames or responses may be transmitted by the shared AP 102-b and the first wireless STA 104-a.

For example, in response to the poll message included in the invite frame, the first wireless STA 104-a may transmit, and the sharing AP 102-a may receive, a first ICR1 frame.

When the sharing AP 102-a and the shared AP 102-b operate in accordance with the CoBF scheme, the first ICR1 frame may include an indication confirming an availability of the first wireless STA 104-a to participate in further frame exchanges with the sharing AP 102-a. When operating in accordance with the CoBF scheme, the first ICR1 frame may be transmitted in TB PPDU format in the case that multiple wireless STAs 104 are scheduled by the sharing AP 102-a or in the case that a response frame from the shared AP 102-b is polled by the invite frame. Otherwise, the first ICR1 frame may be transmitted in non-TB PPDU format.

When the sharing AP 102-a and the shared AP 102-b operate in accordance with the CSR scheme, the first ICR1 frame may be monitored by both the sharing AP 102-a and the shared AP 102-b to measure a received power associated with the first ICR1 frame. For instance, the sharing AP 102-a may measure the received power of the first ICR1 frame as R₁ and the shared AP 102-b may measure the received power of the first ICR1 frame as R₂. When operating in accordance with the CSR scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

Further, in response to the invite frame the shared AP 102-b may transmit, and the sharing AP 102-a may receive, a second ICR2 frame.

When the sharing AP 102-a and the shared AP 102-b operate in accordance with the CoBF scheme, the second ICR2 frame may include an indication confirming an availability of the shared AP 102-b to participate in further frame exchanges with the sharing AP 102-a and may prepare the shared AP 102-b for the further frame exchanges. In some examples, if solicited, the second ICR2 frame may provide easier shared transmit opportunity recovery for the sharing AP 102-a in the event the shared AP 102-b is unavailable or unresponsive. Otherwise, the sharing AP 102-a may have to wait for a response frame and then reclaim medium (such as channel) access a Point coordination function (PCF) interframe space (PIFS) after reception of the first ICR1 frame. Transmission of the second ICR2 frame in the unified frame transmission sequence 600 may be optional in the CoBF scheme.

When the sharing AP 102-a and the shared AP 102-b operate in accordance with the CSR scheme, the second ICR2 frame might not be included (such as is not included) in the unified frame transmission sequence 600 because the shared AP 102-b may be engaged in monitoring for the first ICR1 frame transmitted by the first wireless STA 104-a in order to measure its received power.

In some examples, after sending the invite frame, the shared AP 102-b may transmit, and the sharing AP 102-a may receive, a response frame.

When the sharing AP 102-a and the shared AP 102-b operate in accordance with the CoBF scheme, the response frame may include an indication of acceptance of the invitation to participate in the further frame exchange. In some examples, the response frame may additionally include information associated with the second wireless STA 104-b scheduled by the shared AP 102-b. In some examples, the response frame may additionally act as an ICF to poll the second wireless STA 104-b to respond with an ICR indicating availability of the second wireless STA 104-b for the frame exchange in accordance with the CSR scheme and also to prepare the second wireless STA 104-b for the frame exchange in accordance with the CSR scheme. For instance, the response frame may include a poll message that causes the second wireless STA 104-b to be polled.

When the sharing AP 102-a and the shared AP 102-b operate in accordance with the CSR scheme, the response frame may optionally be included in the unified frame transmission sequence 600. In some examples, the response frame may be used by the shared AP 102-b to poll the second wireless STA 104-b to ensure its availability and prepare the second wireless STA 104-b for further frame exchanges, such as for UHR wireless STAs 104 (such as to notify the UHR wireless STAs 104 to follow an extended timeout duration before deactivating a eMLSR link, as in switching from active to listen modes on that link). For instance, the response frame may include a poll message that polls a response frame from the second wireless STA 104-b.

When operating in accordance with the CSR scheme with multiple shared APs 102-b an overlap between the response frames from the multiple shared APs 102-b may occur (as well as overlapping ICRs from the STAs 104-b associated APs 102-b). To resolve this, in one implementation, the sharing AP 102-a may specify only one shared AP 102-b that is allowed to transmit a response frame and from which an ICR frame from its associated wireless STAs 104-b may be received. In another implementation, the sharing AP 102-a may allow up to all shared APs 102-b to transmit response frames and to receive ICR responses from their associated wireless STAs 104-b. In this implementation the overlapping response frames transmitted by all shared APs 102-b might not all be successfully decoded at their respective wireless STAs 104. This may act to manage, reduce, or limit interference among the shared APs 102-b and their associated STAs 104-b. To ensure that the sharing AP 102-a is able to send the trigger/synchronization frame at the correct time, the fourth ICR4 frame transmitted after the response frame sent might not be optional in some cases. By having the fourth ICR4 frame, the trigger/synchronization frame may be received a short interframe space (SIFS) after this ICR frame. The sharing AP 102-a may specify in the invite frame a duration of the response frame so that the sharing AP 102-a may calculate when to send the fourth ICR4 frame without relying on successful reception of the overlapping response frames.

In some implementations, an eMLSR-supporting frame transmission sequence for the CoBF scheme may be used when operating in accordance with the CSR scheme. While in some cases, overhead may result from the response frame and its solicited ICR frame, the response frame and its solicited ICR frames may be useful in the case that the shared AP 102-b wants to schedule eMLSR or DPS wireless STA 104 with the CSR shared transmission opportunity.

In response to the response frame or the poll message included therein, the second wireless STA 104-b may transmit, and the shared AP 102-b may receive, a third ICR3 frame.

When the sharing AP 102-a and the shared AP 102-b operate in accordance with the CoBF scheme, the third ICR3 frame may include an indication confirming an availability of the second wireless STA 104-b to participate in further frame exchanges with the shared AP 102-b.

When the sharing AP 102-a and the shared AP 102-b operate in accordance with the CSR scheme, the third ICR3 frame may optionally be included in the unified frame transmission sequence 600, as the third ICR3 frame might be considered overhead. In some examples, however, the third ICR3 frame may be used by the shared AP 102-b to poll the second wireless STA 104-b to ensure its availability and prepare it for further frame exchanges (such as eMLSR/DPS), such as for UHR wireless STAs 104. For instance, the response frame may include a poll message that causes the second wireless STA 104-b to be polled.

In some examples, in response to the response frame or after receiving the response frame, the sharing AP 102-a may transmit, and the shared AP 102-b may receive, a fourth ICR4 frame.

When the sharing AP 102-a and the shared AP 102-b operate in accordance with the CoBF scheme, the fourth ICR4 frame may include an indication of an unavailability of the first wireless STA 104-a. The shared AP 102-b may use the indication of unavailability to refrain from applying beam nulling or to terminate the shared transmission opportunity. Transmission of the fourth ICR4 frame in the unified frame transmission sequence 600 may be optional in the CoBF scheme.

When the sharing AP 102-a and the shared AP 102-b operate in accordance with the CSR scheme, the fourth ICR4 frame might not be included in the unified frame transmission sequence 600 (unless multiple shared APs 102-b are sending response frames) as the fourth ICR4 frame may be considered overhead.

After receipt of the first response frame, the sharing AP 102-a may transmit, and the shared AP 102-b may receive, a trigger/synchronization frame.

When the sharing AP 102-a and the shared AP 102-b operate in accordance with the CoBF scheme, the trigger/synchronization frame may act as a frequency and time synchronization reference signal. The shared AP 102-b may use the frequency and time synchronization reference signal when transmitting the downlink PPDU transmission. In some examples, the trigger/synchronization frame may include additional information for generation of a common preamble.

When the sharing AP 102-a and the shared AP 102-b operate in accordance with the CSR scheme, the trigger/synchronization frame may include an indication of whether the one or more shared APs 102-b agreed to participate (or not participate) in the further frame exchanges by sending an updated list of shared APs 102-b that have accepted the CSR invitation. The trigger/synchronization frame also may include the received power (R₁) associated with the first ICR1 frame as measured by the sharing AP 102-a, the transmit power (T₁) associated with the sharing AP 102-a, the SIR threshold accepted at the first wireless STA 104-a, (or a difference therebetween, such as T₁−SIR), a start time and end time associated with transmission of a coordinated downlink PPDU transmission, or any combination thereof. In some examples, the trigger/synchronization frame may act as a frequency and time reference frame and may be used by the shared AP 102-b for frequency and time synchronization. In some examples, the trigger/synchronization frame may provide BA radio unit (RU) allocation for each BSS and may provide padding.

Responsive to communication of the various frames, the sharing AP 102-a and the shared AP 102-b may coordinate transmission, within the shared transmission opportunity, of one or more coordinated downlink PPDU transmissions to the first wireless STA 104-a and the second wireless STA 104-b, respectively. In some examples, the one or more coordinated downlink PPDU transmissions are transmitted in accordance with the frequency and time synchronization reference signal included in the trigger/synchronization frame.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

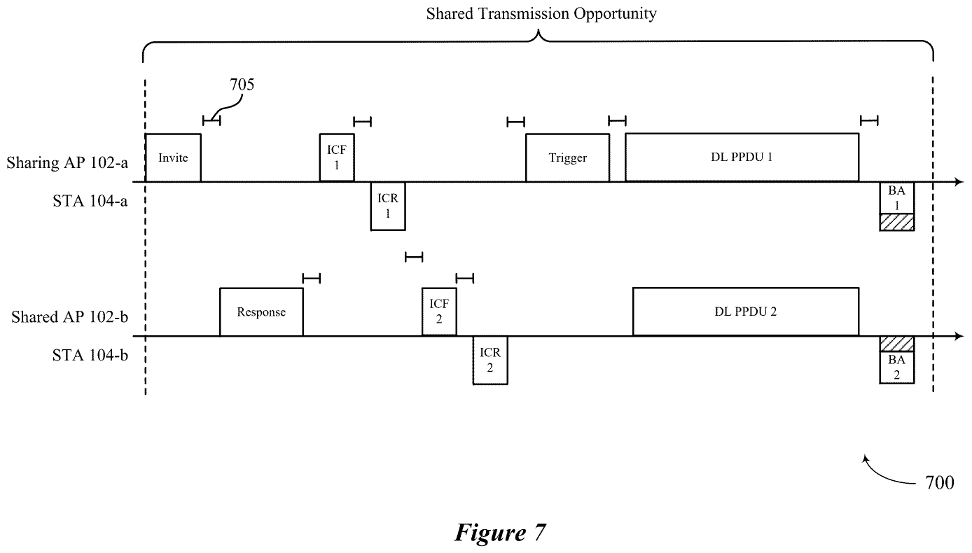

FIG. 7 shows an example of a unified frame transmission sequence 700 that supports techniques for a unified frame transmission sequence for CoBF and CSR. In some examples, the unified frame transmission sequence 700 may implement or be implemented by aspects of the wireless communication network 100, the wireless environment 200, the frame transmission sequences 300, 400, 500, and 700 described with reference to FIGS. 1-6, or any combination thereof. For example, the unified frame transmission sequence 700 may include an invite frame, one or more ICR frames, a response frame, a trigger/synchronization frame, one or more BA frames, and one or more downlink PPDUs. The various frames and transmissions may be separated by one or more gaps 705. The unified frame transmission sequence 700 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 through 6. The sharing AP 102-a may identify one or more shared transmission opportunities during which the sharing AP 102-a and the one or more shared APs 102-b may simultaneously transmit communications to the wireless STA 104-a and wireless STA 104-b, respectively.

In accordance with aspects described herein, a frame transmission sequence associated with the CoBF scheme (such as frame transmission sequence 300) and a second variant frame transmission sequence associated with the CSR scheme (such as frame transmission sequence 500) may be unified into a common frame transmission sequence, such as the unified frame transmission sequence 700. In some examples, the second variant frame transmission sequence associated with the CSR scheme may be a subset of the frame transmission sequence associated with a CoBF scheme. In the unified frame transmission sequence 700, the various frames may carry different information depending on which of the coordinated AP schemes the sharing AP 102-a and the sharing AP 102-a operate in accordance with.

For instance, the sharing AP 102-a may transmit an invite frame, and the shared AP 102-b may receive, during a shared transmission opportunity, the invite frame. The invite frame may indicate that the shared AP 102-b (and one or more wireless STAs 104) may operate in accordance with the unified frame transmission sequence 700, where the frame transmission sequence is associated with a first coordinated AP scheme, such as the CoBF AP scheme, a second coordinated AP scheme, such as the CSR AP scheme, or other coordinated AP schemes. For example, the invite frame may indicate to operate in accordance with the first coordinated AP scheme and the second coordinated AP scheme.

When the sharing AP 102-a and the shared AP 102-b operate in accordance with the CoBF scheme, the invite frame may include an invitation to the shared AP 102-b to perform a CoBF operation (such as to participate in the frame exchange in accordance with the CoBF scheme) and may additionally include information associated with one or more wireless STAs 104 scheduled by the sharing AP 102-a, such as the first wireless STA 104-a.

When the sharing AP 102-a and the shared AP 102-b operate in accordance with the CSR scheme, the invite frame may be used for the following purposes. For example, invite frame may invite an initial set of candidate shared APs 102-b to participate in a CSR shared transmission opportunity (TXOP), and the invite frame may provide an early indication to candidate shared APs 102-b to be prepared for monitoring the ICR response from the first wireless STAs 104-a of the sharing AP 102-a and measuring a received RSSI of the ICR. As such, the invite frame may include an invitation to one or more shared APs 102-b to perform a CSR operation (such as to participate in the frame exchange in accordance with the CRS scheme). In some examples, the invite may include padding. In the example of the CSR scheme, the invite frame may not be enabled to poll a response frame from the shared AP 102-b because the shared AP 102-b may be engaged in monitoring for an ICR (such as a first ICR1) transmitted by the first wireless STA 104-a in order to measure its received power. The invite frame may additionally provide an indication to the shared AP 102-b to prepare to monitor for one or more ICRs in accordance with the unified frame transmission sequence 700. In such examples, when the CSR scheme is a subset of the CoBF scheme, the CSR scheme may include a single shared AP 102-b (such as when following a CoBF operation includes a single shared AP 102-b). To enable multiple shared APs 102-b to participate in the CSR operation, the invite frame may solicit one or more response frames from the candidate shared APs 102-b, which may be sent simultaneously according to a TB PPDU format. To relatively decrease instances where the shared APs 102-b may become out of sync (such as sending overlapping transmissions) the invite frame may indicate a total quantity of shared APs 102-b to be included in the CSR TXOP and indicate an assigned order for each of the candidate shared APs 102-b (e.g., within the unified frame transmission sequence 700). In some examples, the order may be used by each of the candidate shared APs 102-b to determine when to transmit one or more respective ICF/ICR frame exchanges with one or more respective scheduled clients (such as the ICF/ICR frame exchanges between each of the sharing APs 102-a and the shared APs 102-b and the respective clients may be staggered in time).

In some cases, after sending the invite frame, the shared AP 102-b may transmit, and the sharing AP 102-a may receive, a response frame.

When the sharing AP 102-a and the shared AP 102-b operate in accordance with the CoBF scheme, the response frame may include an indication of acceptance of the invitation to participate in the further frame exchange. In some examples, the response frame may additionally include information associated with the second wireless STA 104-b scheduled by the shared AP 102-b.

When the sharing AP 102-a and the shared AP 102-b operate in accordance with the CSR scheme, the response frame may optionally be included in the unified frame transmission sequence 700.

In some examples, a resource unit (RU) allocation for each candidate shared AP 102 may be indicated in the invite frame (such as for BA transmission in the CoBF scheme, the CSR scheme, or both).

When operating in accordance with the CSR scheme with multiple shared APs 102-b an overlap between the response frames from the multiple shared APs 102-b may occur. To resolve this, each of the shared APs 102-b may be triggered to send the response frames in an OFDMA mode according to the TB PPDU format.

After receipt of the response frame, the sharing AP 102-a may transmit, and the one or more first wireless STAs 104-a may receive, a first ICF1.

When the sharing AP 102-a and the shared AP 102-b operate in accordance with the CoBF scheme, the first ICF1 may poll the one or more first wireless STAs 104-a and prepare the one or more first wireless STAs 104-a for further frame exchanges. For example, the first ICF1 may include a poll message that causes the one or more first wireless STAs 104-a to be polled.

When the sharing AP 102-a and the shared AP 102-b operate in accordance with the CSR scheme, the first ICF1 may poll the first wireless STA 104-a to respond with an ICR indicating availability of the first wireless STA 104-a for the frame exchange in accordance with the CSR scheme (such as the sharing AP 102-a may transmit the first ICF1 to solicit an ICR from the first wireless STA 104-a). In some examples, the first ICF1 may include padding. In the case of the CSR scheme, the first ICF1 may not be enabled to poll a response frame from the shared AP 102-b because the shared AP 102-b may be engaged in monitoring for an ICR (such as a first ICR1) transmitted by the first wireless STA 104-a in order to measure its received power. That is, the first ICF1 may solicit an ICR response from the first wireless STA 104-a (such as STA1) based on which RSSI measurements are made (such as by the sharing AP 102-a, the shared AP 102-b, or both) which may be utilized for a shared AP 102-b transmission power calculation.

In response to the first ICF1, the first wireless STA 104-a may transmit, and the sharing AP 102-a, the shared AP 102-b, or both may receive, a first ICR1 frame.

When the sharing AP 102-a and the shared AP 102-b operate in accordance with the CoBF scheme, the first ICR1 frame may include an indication confirming an availability of the first wireless STA 104-a to participate in further frame exchanges with the sharing AP 102-a. When operating in accordance with the CoBF scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

When the sharing AP 102-a and the shared AP 102-b operate in accordance with the CSR scheme, the first ICR1 frame may be monitored by both the sharing AP 102-a and the shared AP 102-b to measure a received power associated with the first ICR1 frame. For instance, the sharing AP 102-a may measure the received power of the first ICR1 frame as R₁ and the shared AP 102-b may measure the received power of the first ICR1 frame as R₂. When operating in accordance with the CSR scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

After receipt of the first ICR1, the shared AP 102-b may transmit, and the one or more second wireless STAs 104-b may receive, a second ICF2.

When the sharing AP 102-a and the shared AP 102-b operate in accordance with the CoBF scheme, the second ICF2 may poll the one or more second wireless STAs 104-b and prepare the one or more second wireless STAs 104-b for further frame exchanges. For example, the second ICF2 may include a poll message that causes the one or more second wireless STAs 104-b to be polled.

When the sharing AP 102-a and the shared AP 102-b operate in accordance with the CSR scheme, the second ICF2 may be utilized to poll a client (such as the second wireless STA 104-b, or STA2) to confirm an availability of the second wireless STA 104-b and to prepare the second wireless STA 104-b for further frame exchanges (such as in the cases of eMLSR or DPS clients for UHR clients to notify the UHR wireless STAs 104 to follow an extended timeout duration before deactivating an eMLSR link, as in switching from active to listen modes on that link). The second ICF2 may poll the second wireless STA 104-b to respond with an ICR indicating availability of the second wireless STA 104-b for the frame exchange in accordance with the CSR scheme (such as the shared AP 102-b may transmit the second ICF2 to solicit an ICR from the second wireless STA 104-b). In some examples, the second ICF2 may include padding.

When the sharing AP 102-a and the shared AP 102-b operate in accordance with the CoBF scheme, the second ICR2 frame may include an indication confirming an availability of the shared AP 102-b to participate in further frame exchanges with the sharing AP 102-a and may prepare the shared AP 102-b for the further frame exchanges.

When the sharing AP 102-a and the shared AP 102-b operate in accordance with the CSR scheme, the second ICF2 may be used by the shared AP 102-b to poll the second wireless STA 104-b to confirm its availability and prepare the second wireless STA 104-b for further frame exchanges, such as for UHR wireless STAs 104 (such as to notify the UHR wireless STAs 104 to follow an extended timeout duration before deactivating an eMLSR link, as in switching from active to listen modes on that link). For instance, the second ICF2 may include a poll message that polls a second ICR2 from the second wireless STA 104-b. In such cases, the second ICR2 may confirm the availability of the second wireless STA 104-b (such as STA2) for further frame exchanges. In some examples, the ICR and ICF frames (e.g., ICF1, ICF2, ICR1, ICR2) may be transmitted in a non-OFDMA mode. In some examples, the ICR frames (e.g., ICR1, ICR2) may be transmitted in an OFDMA mode when multiple STAs are triggered by an ICF at the same time (e.g., ICRs are triggered for transmission at a same time but in different RUs and may include different information).

After receipt of the first ICR1 or the second ICR2 (such as where an ICF-ICR frame exchange was performed between the shared AP 102-b and its STA 104-b), the sharing AP 102-a may transmit, and the shared AP 102-b may receive, a trigger/synchronization frame. The shared AP 102-b may indicate in the Response frame whether shared AP 102-b will do an ICF-ICR frame exchange with its associated STA 104-b or not.

When the sharing AP 102-a and the shared AP 102-b operate in accordance with the CoBF scheme, the trigger/synchronization frame may act as a frequency and time synchronization reference signal. The shared AP 102-b may use the frequency and time synchronization reference signal when transmitting the downlink PPDU transmission. In some examples, the trigger/synchronization frame may include additional information for generation of a common preamble.

When the sharing AP 102-a and the shared AP 102-b operate in accordance with the CSR scheme, the trigger/synchronization frame may include an indication of whether the one or more shared APs 102-b agreed to participate (or not participate) in the further frame exchanges by sending an updated list of shared APs 102-b that have accepted the CSR invitation. That is, the trigger/synchronization frame may indicate a decision of the shared AP 102-b (such as a shared AP 102-b choice, or an acceptance or a rejection). The trigger/synchronization frame also may include the received power (R₁) associated with the first ICR1 frame as measured by the sharing AP 102-a, the transmit power (T₁) associated with the sharing AP 102-a, the SIR threshold accepted at the first wireless STA 104-a, (or a difference therebetween, such as T₁−SIR), a start time and end time associated with transmission of a coordinated downlink PPDU transmission, or any combination thereof. In some examples, the trigger/synchronization frame may act as a frequency and time reference frame and may be used by the shared AP 102-b for frequency and time synchronization. In some examples, the trigger/synchronization frame may provide BA RU allocation for each BSS and may provide padding. In some examples, the trigger/synchronization frame may include additional information for generation of a common preamble in the DL PPDUs.

In the example of a first variant of the CSR scheme further described herein with reference to FIG. 4, offline interference estimation may be performed. In this implementation, interference estimation may be performed offline in the background by collecting RSSI reports (such as beacon reports including RSSI information) from associated wireless STAs 104 including RSSI information measured with respect to neighbor APs 102. The sharing AP 102-a may utilize the RSSI reports to estimate interference levels caused by neighbor APs 102 on its associated wireless STA 104. Each of the APs 102 may store an interference estimate value for each of its associated wireless STAs 104 per OBSS. Based on the estimates, the sharing AP 102-a may decide which other APs 102 to poll to share the shared transmission opportunity and how much transmit power backoff may be applied to minimize interference during the shared transmission opportunity. The sharing AP 102-a may signal, via the CSR trigger frame, the offline interference estimation and the transmit power backoff amount to the shared AP 102-b. The first variant of the CSR scheme may be supported by the frame sequence described herein since the first variant of the CSR scheme utilizes a trigger frame, which is present in the frame sequence described herein. The additional frames of the sequence (such as frames other than the trigger frame, such as the first ICF1, the second ICF2, and the like) may incur additional overhead for the first variant of the CSR scheme.

Responsive to communication of the various frames, the sharing AP 102-a and the shared AP 102-b may coordinate transmission, within the shared transmission opportunity, of one or more coordinated downlink PPDU transmissions to the first wireless STA 104-a and the second wireless STA 104-b, respectively. In some examples, the one or more coordinated downlink PPDU transmissions are transmitted in accordance with the frequency and time synchronization reference signal included in the trigger/synchronization frame.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

In some cases, eMLSR (such as legacy eMLSR) clients may be unsupported by this CSR sequence because the sequence may include silent periods after the ICF/ICR exchanges between the sharing APs 102-a and shared APs 102-b and their associated clients (such as the unified frame transmission sequence 700 may support UHR clients to notify the clients to follow the extended timeout duration before deactivating the eMLSR link). In some cases, eMLSR clients may be supported. For example, an alternative eMLSR-supporting transmission sequence for CoBF may be used for CSR (such as with some overhead). The overhead may be incurred from the invite and response frames, and ICF/ICR frame exchanges performed between the sharing AP 102-a and shared APs 102-b, and the respective clients, respectively.

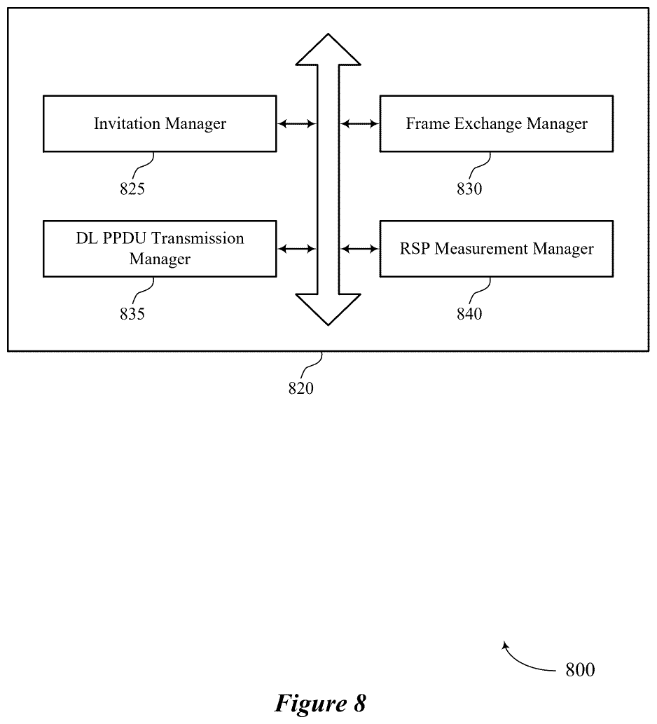

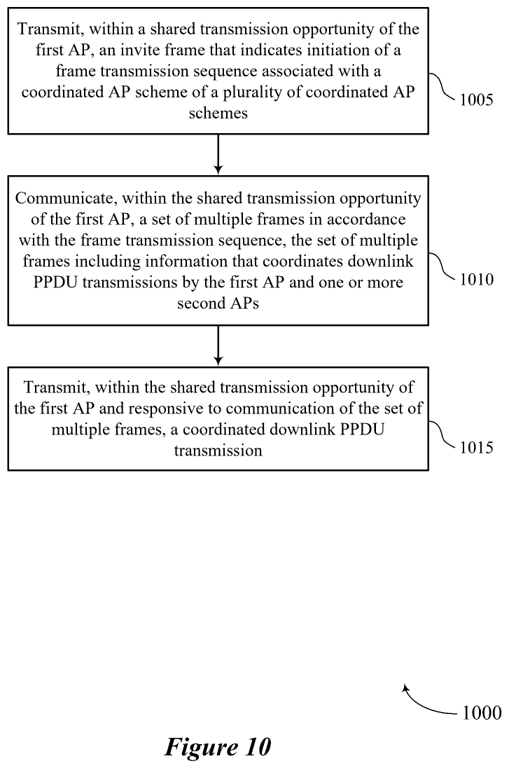

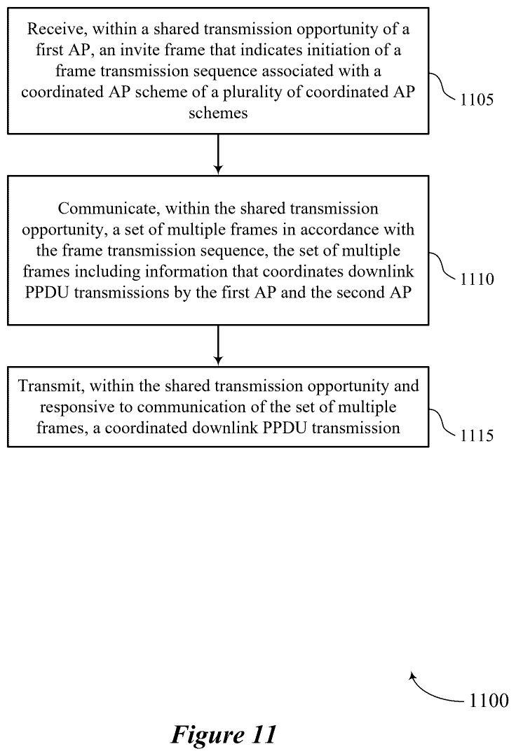

FIG. 8 shows a block diagram of an example wireless communication device 800 that supports unified frame transmission sequence for coordinated beamforming and coordinated spatial reuse. In some examples, the wireless communication device 800 is configured to perform the processes 1000 and 1100 described with reference to FIGS. 10 and 11, respectively. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes an invitation manager 825, a frame exchange manager 830, a DL PPDU transmission manager 835, and an RSP measurement manager 840. Portions of one or more of the invitation manager 825, the frame exchange manager 830, the DL PPDU transmission manager 835, and the RSP measurement manager 840 may be implemented at least in part in hardware or firmware. For example, one or more of the invitation manager 825, the frame exchange manager 830, the DL PPDU transmission manager 835, and the RSP measurement manager 840 may be implemented at least in part by at least a processor or a modem. In some examples, portions of one or more of the invitation manager 825, the frame exchange manager 830, the DL PPDU transmission manager 835, and the RSP measurement manager 840 may be implemented at least in part by a processor and software in the form of processor-executable code stored in memory.

The wireless communication device 800 may support wireless communication in accordance with examples as disclosed herein. The invitation manager 825 is configurable or configured to transmit, within a shared transmission opportunity of the first AP, an invite frame that indicates initiation of a frame transmission sequence associated with a coordinated AP scheme of a plurality of coordinated AP schemes, where the plurality of coordinated AP schemes includes a first coordinated AP scheme and a second coordinated AP scheme. The frame exchange manager 830 is configurable or configured to communicate, within the shared transmission opportunity of the first AP, a set of multiple frames in accordance with the frame transmission sequence, the set of multiple frames including information that coordinates downlink PPDU transmissions by the first AP and one or more second APs. The DL PPDU transmission manager 835 is configurable or configured to transmit, within the shared transmission opportunity of the first AP and responsive to communication of the set of multiple frames, a coordinated downlink PPDU transmission.

In some examples, the set of multiple frames includes one or more initial control response frames, a response frame, a trigger frame, or any combination thereof.

In some examples, the invite frame includes an invitation to perform a CoBF operation between the first AP and a second AP of the one or more second APs.

In some examples, the first coordinated AP scheme includes a CoBF scheme.

In some examples, the invite frame includes a poll message of the CoBF scheme and requests a wireless station to perform frame exchange associated with the CoBF scheme.

In some examples, to support communicating the set of multiple frames in accordance with the frame transmission sequence, the frame exchange manager 830 is configurable or configured to receive, from the wireless station and based on the poll message, a first initial control response frame that indicates availability of the wireless station to participate in frame exchange associated with the CoBF scheme.

In some examples, the frame exchange manager 830 is configurable or configured to prepare, based on the first initial control response frame, to participate in the frame exchange with the wireless station.

In some examples, to support communicating the set of multiple frames in accordance with the frame transmission sequence, the frame exchange manager 830 is configurable or configured to receive, from the second AP and based on the invitation, a second initial control response frame, a response frame, or both, where the second initial control response frame and the response frame indicate availability of the second AP to participate in frame exchange associated with the CoBF scheme.

In some examples, the frame exchange manager 830 is configurable or configured to prepare, based on the second initial control response frame, to participate in the frame exchange with the second AP.

In some examples, to support communicating the set of multiple frames in accordance with the frame transmission sequence, the frame exchange manager 830 is configurable or configured to transmit, to the second AP, a trigger frame, where the trigger frame is a frequency and time synchronization reference frame, and where the coordinated downlink PPDU transmission is communicated in accordance with the frequency and time synchronization reference frame.

In some examples, the invite frame includes an invitation to perform a CSR operation between the first AP and a second AP of the one or more second APs.

In some examples, the second coordinated AP scheme includes a CSR scheme.

In some examples, the invite frame includes a poll message of the CSR scheme and requests a wireless station to perform frame exchange associated with the CSR scheme and to transmit an initial coordinated response frame.

In some examples, to support communicating the set of multiple frames in accordance with the frame transmission sequence, the frame exchange manager 830 is configurable or configured to receive, from the wireless station and based on the poll message, a first initial control response frame that indicates availability of the wireless station to participate in frame exchange associated with the CSR scheme.

In some examples, the RSP measurement manager 840 is configurable or configured to measure, based on the first initial control response frame, a received signal power associated with the wireless station.

In some examples, to support communicating the set of multiple frames in accordance with the frame transmission sequence, the frame exchange manager 830 is configurable or configured to transmit, to the second AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples, to support communicating the set of multiple frames in accordance with the frame transmission sequence, the frame exchange manager 830 is configurable or configured to receive, from the second AP and based on the invitation, a response frame that indicates availability of the second AP to participate in frame exchange associated with the CSR scheme.

Additionally, or alternatively, the wireless communication device 800 may support wireless communication in accordance with examples as disclosed herein. In some examples, the invitation manager 825 is configurable or configured to receive, within a shared transmission opportunity of a first AP, an invite frame that indicates initiation of a frame transmission sequence associated with a coordinated AP scheme of a plurality of coordinated AP schemes, wherein the plurality of coordinated AP schemes includes a first coordinated AP scheme and a second coordinated AP scheme. In some examples, the frame exchange manager 830 is configurable or configured to communicate, within the shared transmission opportunity, a set of multiple frames in accordance with the frame transmission sequence, the set of multiple frames including information that coordinates downlink PPDU transmissions by the first AP and the second AP. In some examples, the DL PPDU transmission manager 835 is configurable or configured to transmit, within the shared transmission opportunity and responsive to communication of the set of multiple frames, a coordinated downlink PPDU transmission.

In some examples, the set of multiple frames includes an initial control response frame, a response frame, a trigger frame, or any combination thereof.

In some examples, the invite frame includes an invitation to perform a CoBF operation between the first AP and the second AP.

In some examples, the first coordinated AP scheme includes a CoBF scheme.

In some examples, to support communicating the set of multiple frames in accordance with the frame transmission sequence, the frame exchange manager 830 is configurable or configured to transmit, to the first AP and based on the invitation, a first initial control response frame, a response frame, or both, where the first initial control response frame and the response frame indicate availability of the second AP to participate in frame exchange associated with the CoBF scheme.

In some examples, to support communicating the set of multiple frames in accordance with the frame transmission sequence, the frame exchange manager 830 is configurable or configured to receive, from a wireless station and based on the invitation, a second initial control response frame that indicates availability of the wireless station to participate in frame exchange associated with the CoBF scheme.

In some examples, the frame exchange manager 830 is configurable or configured to prepare, based on the second initial control response frame, to participate in the frame exchange with the wireless station.

In some examples, to support communicating the set of multiple frames in accordance with the frame transmission sequence, the frame exchange manager 830 is configurable or configured to receive, from the first AP, a trigger frame, where the trigger frame is a frequency and time synchronization reference frame, and where the coordinated downlink PPDU transmission is communicated in accordance with the frequency and time synchronization reference frame.

In some examples, the invite frame includes an invitation to perform a CSR operation between the first AP and the second AP.

In some examples, the second coordinated AP scheme includes a CSR scheme.

In some examples, to support communicating the set of multiple frames in accordance with the frame transmission sequence, the frame exchange manager 830 is configurable or configured to transmit, to the first AP and based on the invitation, a response frame that indicates availability of the second AP to participate in frame exchange associated with the CSR scheme.

In some examples, the RSP measurement manager 840 is configurable or configured to monitor for an initial control response frame transmitted by a wireless station associated with the first AP. In some examples, the RSP measurement manager 840 is configurable or configured to measure, based on the initial control response frame, a received signal power associated with the wireless station.

In some examples, to support communicating the set of multiple frames in accordance with the frame transmission sequence, the frame exchange manager 830 is configurable or configured to receive, from the first AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples, the DL PPDU transmission manager 835 is configurable or configured to adjusting, base at least in part on the trigger frame, a transmit power, where the coordinated downlink PPDU transmission is transmitted based on the adjusted transmit power.

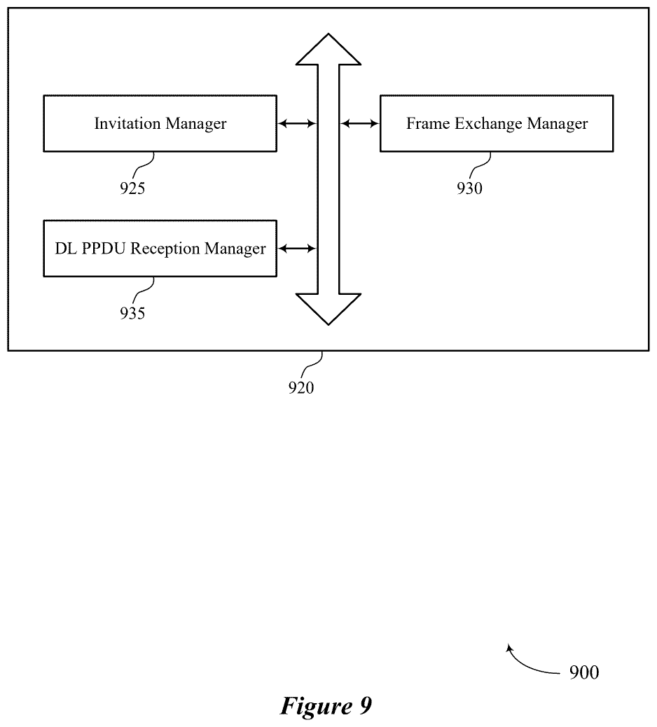

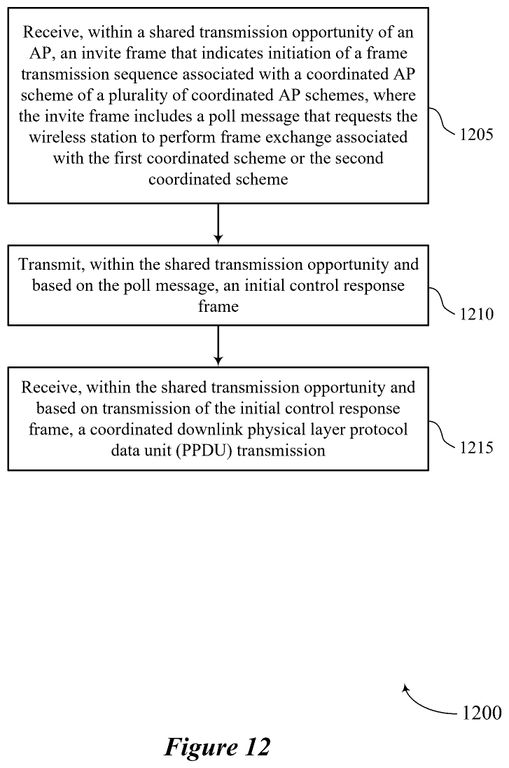

FIG. 9 shows a block diagram of an example wireless communication device 900 that supports unified frame transmission sequence for coordinated beamforming and coordinated spatial reuse. In some examples, the wireless communication device 900 is configured to perform the process 1200 described with reference to FIG. 12. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system.

The wireless communication device 900 includes an invitation manager 925, a frame exchange manager 930, and a DL PPDU reception manager 935. Portions of one or more of the invitation manager 925, the frame exchange manager 930, and the DL PPDU reception manager 935 may be implemented at least in part in hardware or firmware. For example, one or more of the invitation manager 925, the frame exchange manager 930, and the DL PPDU reception manager 935 may be implemented at least in part by at least a processor or a modem. In some examples, portions of one or more of the invitation manager 925, the frame exchange manager 930, and the DL PPDU reception manager 935 may be implemented at least in part by a processor and software in the form of processor-executable code stored in memory.

The wireless communication device 900 may support wireless communications in accordance with examples as disclosed herein. The invitation manager 925 is configurable or configured to receive, within a shared transmission opportunity of an access point (AP), an invite frame that indicates initiation of a frame transmission sequence associated with a coordinated transmission scheme of a plurality of coordinated AP schemes, where the plurality of coordinated AP schemes includes a first coordinated AP scheme and a second coordinated AP scheme, where the invite frame includes a poll message that requests the wireless station to perform frame exchange associated with the first coordinated AP scheme or the second coordinated AP scheme. The frame exchange manager 930 is configurable or configured to transmit, within the shared transmission opportunity and based on the poll message, an initial control response frame. The DL PPDU reception manager 935 is configurable or configured to receive, within the shared transmission opportunity and based on transmission of the initial control response frame, a coordinated downlink PPDU transmission.

FIG. 10 shows a flowchart illustrating an example process 1000 performable by or at a first AP that supports unified frame transmission sequence for coordinated beamforming and coordinated spatial reuse. The operations of the process 1000 may be implemented by a first AP or its components as described herein. For example, the process 1000 may be performed by a wireless communication device, such as the wireless communication device 800 described with reference to FIG. 8, operating as or within a wireless AP. In some examples, the process 1000 may be performed by a wireless AP, such as one of the APs 102 described with reference to FIG. 1.

In some examples, in 1005, the first AP may transmit, within a shared transmission opportunity of the first AP, an invite frame that indicates a frame transmission sequence, where the frame transmission sequence is associated with a first coordinated AP scheme and a second coordinated AP scheme. The operations of 1005 may be performed in accordance with examples as disclosed herein. In some implementations, aspects of the operations of 1005 may be performed by an invitation manager 825 as described with reference to FIG. 8.

In some examples, in 1010, the first AP may communicate, within the shared transmission opportunity of the first AP, a set of multiple frames in accordance with the frame transmission sequence, the set of multiple frames including information that coordinates downlink PPDU transmissions by the first AP and one or more second APs. The operations of 1010 may be performed in accordance with examples as disclosed herein. In some implementations, aspects of the operations of 1010 may be performed by a frame exchange manager 830 as described with reference to FIG. 8.

In some examples, in 1015, the first AP may transmit, within the shared transmission opportunity of the first AP and responsive to communication of the set of multiple frames, a coordinated downlink PPDU transmission. The operations of 1015 may be performed in accordance with examples as disclosed herein. In some implementations, aspects of the operations of 1015 may be performed by a DL PPDU transmission manager 835 as described with reference to FIG. 8.

FIG. 11 shows a flowchart illustrating an example process 1100 performable by or at a second AP that supports unified frame transmission sequence for coordinated beamforming and coordinated spatial reuse. The operations of the process 1100 may be implemented by a second AP or its components as described herein. For example, the process 1100 may be performed by a wireless communication device, such as the wireless communication device 800 described with reference to FIG. 8, operating as or within a wireless AP. In some examples, the process 1100 may be performed by a wireless AP, such as one of the APs 102 described with reference to FIG. 1.

In some examples, in 1105, the second AP may receive, within a shared transmission opportunity of a first AP, an invite frame that indicates initiation of a frame transmission sequence associated with a coordinated AP scheme of a plurality of coordinated AP schemes, where the plurality of coordinated AP schemes includes a first coordinated AP scheme and a second coordinated AP scheme. The operations of 1105 may be performed in accordance with examples as disclosed herein. In some implementations, aspects of the operations of 1105 may be performed by an invitation manager 825 as described with reference to FIG. 8.

In some examples, in 1110, the second AP may communicate, within the shared transmission opportunity, a set of multiple frames in accordance with the frame transmission sequence, the set of multiple frames including information that coordinates downlink PPDU transmissions by the first AP and the second AP. The operations of 1110 may be performed in accordance with examples as disclosed herein. In some implementations, aspects of the operations of 1110 may be performed by a frame exchange manager 830 as described with reference to FIG. 8.

In some examples, in 1115, the second AP may transmit, within the shared transmission opportunity and responsive to communication of the set of multiple frames, a coordinated downlink PPDU transmission. The operations of 1115 may be performed in accordance with examples as disclosed herein. In some implementations, aspects of the operations of 1115 may be performed by a DL PPDU transmission manager 835 as described with reference to FIG. 8.

FIG. 12 shows a flowchart illustrating an example process 1200 performable by or at a wireless station that supports unified frame transmission sequence for coordinated beamforming and coordinated spatial reuse. The operations of the process 1200 may be implemented by a wireless station or its components as described herein. For example, the process 1200 may be performed by a wireless communication device, such as the wireless communication device 900 described with reference to FIG. 9, operating as or within a wireless STA. In some examples, the process 1200 may be performed by a wireless STA, such as one of the STAs 104 described with reference to FIG. 1.

In some examples, in 1205, the wireless station may receive, within a shared transmission opportunity of an AP, an invite frame that indicates initiation of a frame transmission sequence associated with a coordinated AP scheme associated with a plurality of coordinated AP schemes, where the plurality of coordinated AP schemes includes a first coordinated AP scheme and a second coordinated AP scheme, where the invite frame includes a poll message that requests the wireless station to perform frame exchange associated with the first coordinated AP scheme or the second coordinated AP scheme. The operations of 1205 may be performed in accordance with examples as disclosed herein. In some implementations, aspects of the operations of 1205 may be performed by an invitation manager 925 as described with reference to FIG. 9.

In some examples, in 1210, the wireless station may transmit, within the shared transmission opportunity and based on the poll message, an initial control response frame. The operations of 1210 may be performed in accordance with examples as disclosed herein. In some implementations, aspects of the operations of 1210 may be performed by a frame exchange manager 930 as described with reference to FIG. 9.

In some examples, in 1215, the wireless station may receive, within the shared transmission opportunity and based on transmission of the initial control response frame, a coordinated downlink PPDU transmission. The operations of 1215 may be performed in accordance with examples as disclosed herein. In some implementations, aspects of the operations of 1215 may be performed by a DL PPDU reception manager 935 as described with reference to FIG. 9.

The following provides an overview of aspects of the present disclosure:

Aspect 1: A method for wireless communication by a first AP, comprising: transmitting, within a shared transmission opportunity of the first AP, an invite frame that indicates initiation of a joint frame transmission sequence associated with a coordinated AP scheme of a plurality of coordinated AP schemes; communicating, within the shared transmission opportunity of the first AP, a plurality of frames in accordance with the frame transmission sequence, the plurality of frames including information that coordinates downlink physical layer protocol data unit (PPDU) transmissions by the first AP and one or more second APs; and transmitting, within the shared transmission opportunity of the first AP and responsive to communication of the plurality of frames, a coordinated downlink PPDU transmission.

Aspect 2: The method of aspect 1, wherein the plurality of frames comprises one or more initial control response frames, a response frame, a trigger frame, or any combination thereof.

Aspect 3: The method of any of aspects 1 through 2, wherein the invite frame includes an invitation to perform a CoBF operation between the first AP and a second AP of the one or more second APs.

Aspect 4: The method of aspect 3, wherein a first coordinated AP scheme of the plurality of coordinated AP schemes comprises a CoBF scheme, and the invite frame includes an invitation to perform a CoBF operation between the first AP and a second AP of the one or more second APs, an indication of one or more wireless STAs associated with the first AP, or both.

Aspect 5: The method of aspect 4, wherein communicating the plurality of frames in accordance with the joint frame transmission sequence comprises: receiving, from the second AP and based at least in part on the invitation, a response frame, wherein the response frame indicates availability of the second AP to participate in a frame exchange associated with the CoBF scheme, indicates one or more wireless STAs associated with the second AP, or both.

Aspect 6: The method of aspect 4, wherein the invite frame comprises a poll message of the CoBF scheme and requests a wireless station to perform frame exchange associated with the CoBF scheme.

Aspect 7: The method of any of aspects 4 through 6, wherein communicating the plurality of frames in accordance with the joint frame transmission sequence comprises: transmitting an initial control frame comprising a poll message and a request to perform a frame exchange associated with the CoBF scheme.

Aspect 8: The method of aspect 6, wherein communicating the plurality of frames in accordance with the joint frame transmission sequence comprises: receiving, from a wireless STA and based at least in part on the initial control frame, an initial control response frame that indicates an availability of the wireless STA to participate in the frame exchange associated with the CoBF scheme.

Aspect 9: The method of aspect 6, wherein communicating the plurality of frames in accordance with the frame transmission sequence comprises: receiving, from the wireless station and based at least in part on the poll message, a first initial control response frame that indicates availability of the wireless station to participate in frame exchange associated with the CoBF scheme.

Aspect 10: The method of any of aspects 4 through 9, wherein communicating the plurality of frames in accordance with the joint frame transmission sequence comprises: receiving, from the second AP and based at least in part on the invitation, a second initial control response frame, a response frame, or both, wherein the second initial control response frame or the response frame indicate availability of the second AP to participate in frame exchange associated with the CoBF scheme.

Aspect 11: The method of aspect 9, further comprising: preparing, based at least in part on the first initial control response frame, to participate in the frame exchange with the wireless station.

Aspect 12: The method of any of aspects 4 through 11, wherein communicating the plurality of frames in accordance with the frame transmission sequence comprises: receiving, from the second AP and based at least in part on the invitation, a second initial control response frame, a response frame, or both, wherein the second initial control response frame and the response frame indicate availability of the second AP to participate in frame exchange associated with the CoBF scheme.

Aspect 13: The method of aspect 12, further comprising: preparing, based at least in part on the second initial control response frame, to participate in the frame exchange with the second AP.

Aspect 14: The method of any of aspects 3 through 13, wherein communicating the plurality of frames in accordance with the frame transmission sequence comprises: transmitting, to the second AP, a trigger frame, wherein the trigger frame is a frequency and time synchronization reference frame, and wherein the coordinated downlink PPDU transmission is communicated in accordance with the frequency and time synchronization reference frame.

Aspect 15: The method of any of aspects 1 through 14, wherein the invite frame includes an invitation to perform a CSR operation between the first AP and a second AP of the one or more second APs.

Aspect 16: The method of aspect 15, wherein a second coordinated AP scheme of the plurality of coordinated AP schemes comprises a CSR scheme, and the invite frame includes an invitation to perform a CSR operation between the first AP and a second AP of the one or more second APs.

Aspect 17: The method of aspect 16, wherein the invite frame comprises a poll message of the CSR scheme and requests a wireless station to perform frame exchange associated with the CSR scheme and to transmit an initial coordinated response frame.

Aspect 18: The method of aspect 16, wherein communicating the plurality of frames in accordance with the joint frame transmission sequence comprises: receiving, from the second AP and based at least in part on the invitation, a response frame that indicates availability of the second AP to participate in a frame exchange associated with the CSR scheme.

Aspect 19: The method of any of aspects 16 through 18, wherein communicating the plurality of frames in accordance with the joint frame transmission sequence comprises: transmitting an initial control frame comprising a poll message of the CSR scheme, and a request for a wireless STA to perform a frame exchange associated with the CSR scheme and to transmit an initial coordinated response frame.

Aspect 20: The method of aspect 17, wherein communicating the plurality of frames in accordance with the frame transmission sequence comprises: receiving, from the wireless station and based at least in part on the poll message, a first initial control response frame that indicates availability of the wireless station to participate in frame exchange associated with the CSR scheme.

Aspect 21: The method of any of aspects 19 and 20, further comprising: measuring, based at least in part on the first initial control response frame, a received signal power associated with the wireless station.

Aspect 22: The method of any of aspects 16 through 21, wherein communicating the plurality of frames in accordance with the frame transmission sequence comprises: transmitting, to the second AP, a trigger frame that includes an indication of one or more of: a received signal power associated with a wireless station, a transmit power associated with transmission of the coordinated downlink PPDU transmission, a SIR threshold, a start time associated with transmission of the coordinated downlink PPDU transmission, an end time associated with transmission of the coordinated downlink PPDU transmission, or any combination thereof.

Aspect 23: The method of any of aspects 16 through 22, wherein communicating the plurality of frames in accordance with the frame transmission sequence comprises: receiving, from the second AP and based at least in part on the invitation, a second initial control response frame, a response frame, or both, wherein the second initial control response frame or the response frame indicate availability of the second AP to participate in frame exchange associated with the CSR scheme.

Aspect 24: A method for wireless communication by a second AP, comprising: receiving, within a shared transmission opportunity of a first AP, an invite frame that indicates initiation of a joint frame transmission sequence associated with a coordinated AP scheme of a plurality of coordinated AP schemes; communicating, within the shared transmission opportunity, a plurality of frames in accordance with the frame transmission sequence, the plurality of frames including information that coordinates downlink physical layer protocol data unit (PPDU) transmissions by the first AP and the second AP; and transmitting, within the shared transmission opportunity and responsive to communication of the plurality of frames, a coordinated downlink PPDU transmission.

Aspect 25: The method of aspect 24, wherein the plurality of frames comprises an initial control response frame, a response frame, a trigger frame, or any combination thereof.

Aspect 26: The method of any of aspects 24 through 25, wherein the invite frame includes an invitation to perform a CoBF operation between the first AP and the second AP.

Aspect 27: The method of aspect 26, wherein a first coordinated AP scheme of the plurality of coordinated AP schemes comprises a CoBF scheme, and the invite frame includes an invitation to perform a CoBF operation between the first AP and the second AP.

Aspect 28: The method of aspect 27, wherein communicating the plurality of frames in accordance with the frame transmission sequence comprises: transmitting, to the first AP and based at least in part on the invitation, a first initial control response frame, a response frame, or both, wherein the first initial control response frame and the response frame indicate availability of the second AP to participate in frame exchange associated with the CoBF scheme.

Aspect 29: The method of any of aspects 27 through 25, wherein communicating the plurality of frames in accordance with the joint frame transmission sequence comprises: transmitting an initial control frame comprising a poll message and requesting a wireless STA to perform a frame exchange associated with the CoBF scheme.

Aspect 30: The method of aspect 26, wherein communicating the plurality of frames in accordance with the joint frame transmission sequence comprises: receiving, from a wireless STA and based at least in part on the initial control frame, an initial control response frame that indicates availability of the wireless STA to participate in the frame exchange associated with the CoBF scheme.

Aspect 31: The method of any of aspects 27 through 28, wherein communicating the plurality of frames in accordance with the frame transmission sequence comprises: receiving, from a wireless station and based at least in part on the invitation, a second initial control response frame that indicates availability of the wireless station to participate in frame exchange associated with the CoBF scheme.

Aspect 32: The method of aspect 31, further comprising: preparing, based at least in part on the second initial control response frame, to participate in the frame exchange with the wireless station.

Aspect 33: The method of any of aspects 27 through 32, wherein communicating the plurality of frames in accordance with the frame transmission sequence comprises: receiving, from the first AP, a trigger frame, wherein the trigger frame is a frequency and time synchronization reference frame, and wherein the coordinated downlink PPDU transmission is communicated in accordance with the frequency and time synchronization reference frame.

Aspect 34: The method of any of aspects 24 through 33, wherein the invite frame includes an invitation to perform a CSR operation between the first AP and the second AP.

Aspect 35: The method of aspect 34, wherein a second coordinated AP scheme of the plurality of coordinated AP schemes comprises a CSR scheme, and the invite frame includes an invitation to perform a CSR operation between the first AP and the second AP.

Aspect 36: The method of aspect 35, wherein communicating the plurality of frames in accordance with the frame transmission sequence comprises: transmitting, to the first AP and based at least in part on the invitation, a response frame that indicates availability of the second AP to participate in frame exchange associated with the CSR scheme.

Aspect 37: The method of any of aspects 35 through 36, wherein communicating the plurality of frames in accordance with the joint frame transmission sequence comprises: transmitting an initial control frame comprising a poll message and requesting first a wireless STA associated with the second AP to perform a frame exchange associated with the CSR scheme.

Aspect 38: The method of aspect 37, further comprising: monitoring for an initial control response frame transmitted by a second wireless STA associated with the first AP; receiving, from the second wireless STA and based at least in part on the poll message, the initial control response frame that indicates availability of the wireless STA to participate in a frame exchange associated with the CSR scheme; and measuring, based at least in part on the initial control response frame, a received signal power associated with the second wireless STA.

Aspect 39: The method of any of aspects 34 through 36, further comprising: monitoring for an initial control response frame transmitted by a wireless station associated with the first AP; and measuring, based at least in part on the initial control response frame, a received signal power associated with the wireless station.

Aspect 40: The method of any of aspects 34 through 39, wherein communicating the plurality of frames in accordance with the frame transmission sequence comprises: receiving, from the first AP, a trigger frame that includes an indication of one or more of: a received signal power associated with a wireless station, a transmit power associated with transmission of the coordinated downlink PPDU transmission, a SIR threshold, a start time associated with transmission of the coordinated downlink PPDU transmission, an end time associated with transmission of the coordinated downlink PPDU transmission, or any combination thereof.

Aspect 41: The method of aspect 40, further comprising: adjusting, based at least in part on the trigger frame, a transmit power, wherein the coordinated downlink PPDU transmission is transmitted based at least in part on the adjusted transmit power.

Aspect 42: A method for wireless communications by a wireless station, comprising: receiving, within a shared transmission opportunity of an AP, an invite frame that indicates initiation of a joint frame transmission sequence associated with a coordinated AP scheme of a plurality of coordinated AP schemes, wherein the invite frame comprises a poll message that requests the wireless station to perform frame exchange associated with the coordinated AP scheme; transmitting, within the shared transmission opportunity and based at least in part on the poll message, an initial control response frame; and receiving, within the shared transmission opportunity and based at least in part on transmission of the initial control response frame, a coordinated downlink physical layer protocol data unit (PPDU) transmission.

Aspect 43: A first AP for wireless communication, comprising one or more memories storing processor-executable code, and one or more processors coupled with the one or more memories and individually or collectively operable to execute the code to cause the first AP to perform a method of any of aspects 1 through 23.

Aspect 44: A first AP for wireless communication, comprising at least one means for performing a method of any of aspects 1 through 23.

Aspect 45: A non-transitory computer-readable medium storing code for wireless communication, the code comprising instructions executable by one or more processors to perform a method of any of aspects 1 through 23.

Aspect 46: A second AP for wireless communication, comprising one or more memories storing processor-executable code, and one or more processors coupled with the one or more memories and individually or collectively operable to execute the code to cause the second AP to perform a method of any of aspects 24 through 41.

Aspect 47: A second AP for wireless communication, comprising at least one means for performing a method of any of aspects 24 through 41.

Aspect 48: A non-transitory computer-readable medium storing code for wireless communication, the code comprising instructions executable by one or more processors to perform a method of any of aspects 24 through 41.

Aspect 49: A wireless station for wireless communications, comprising one or more memories storing processor-executable code, and one or more processors coupled with the one or more memories and individually or collectively operable to execute the code to cause the wireless station to perform a method of any of aspects 42 through 42.

Aspect 50: A wireless station for wireless communications, comprising at least one means for performing a method of any of aspects 42 through 42.

Aspect 51: A non-transitory computer-readable medium storing code for wireless communications, the code comprising instructions executable by one or more processors to perform a method of any of aspects 42 through 42.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit, within a shared transmission opportunity of the first AP, an invite frame that indicates initiation of a joint frame transmission sequence associated with a coordinated AP scheme of a plurality of coordinated AP schemes;
communicate, within the shared transmission opportunity of the first AP, a plurality of frames in accordance with the joint frame transmission sequence, the plurality of frames including information that coordinates downlink physical layer protocol data unit (PPDU) transmissions by the first AP and one or more second APs; and
transmit, within the shared transmission opportunity of the first AP and responsive to communication of the plurality of frames, a coordinated downlink PPDU transmission.

2. The first AP of claim 1, wherein the plurality of frames comprise one or more initial control frames, one or more initial control response frames, a response frame, a trigger frame, or any combination thereof.

3. The first AP of claim 1, wherein a first coordinated AP scheme of the plurality of coordinated AP schemes comprises a CoBF scheme, and the invite frame includes an invitation to perform a coordinated beamforming (CoBF) operation between the first AP and a second AP of the one or more second APs, an indication of one or more wireless stations associated with the first AP, or both.

4. The first AP of claim 3, wherein, to communicate the plurality of frames in accordance with the joint frame transmission sequence, the processing system is configured to cause the first AP to:
receive, from the second AP and based at least in part on the invitation, a response frame, wherein the response frame indicates availability of the second AP and an indication of an acceptance or rejection of the second AP to participate in a frame exchange associated with the CoBF scheme, indicates one or more wireless stations associated with the second AP, or both.

5. The first AP of claim 3, wherein, to communicate the plurality of frames in accordance with the joint frame transmission sequence, the processing system is configured to cause the first AP to:
transmit an initial control frame comprising a poll message and a request to perform a frame exchange associated with the CoBF scheme.

6. The first AP of claim 5, wherein, to communicate the plurality of frames in accordance with the joint frame transmission sequence, the processing system is configured to cause the first AP to:
receive, from one or more wireless stations and based at least in part on the initial control frame, an initial control response frame that indicates an availability of the one or more wireless stations to participate in the frame exchange associated with the CoBF scheme.

7. The first AP of claim 3, wherein, to communicate the plurality of frames in accordance with the joint frame transmission sequence, the processing system is configured to cause the first AP to:
receive, from the second AP and based at least in part on the invitation, a second initial control response frame, a response frame, or both, wherein the second initial control response frame or the response frame indicate availability of the second AP to participate in frame exchange associated with the CoBF scheme.

8. The first AP of claim 3, wherein, to communicate the plurality of frames in accordance with the joint frame transmission sequence, the processing system is configured to cause the first AP to:
transmit, to the second AP, a trigger frame, wherein the trigger frame is a frequency and time synchronization reference frame, and wherein the coordinated downlink PPDU transmission is communicated in accordance with the frequency and time synchronization reference frame.

9. The first AP of claim 1, wherein:
a second coordinated AP scheme of the plurality of coordinated AP schemes comprises a CSR scheme, and
the invite frame includes an invitation to perform a coordinated spatial reuse (CSR) operation between the first AP and a second AP of the one or more second APs.

10. The first AP of claim 9, wherein, to communicate the plurality of frames in accordance with the joint frame transmission sequence, the processing system is configured to cause the first AP to:
receive, from the second AP and based at least in part on the invitation, a response frame that indicates availability of the second AP to participate in a frame exchange associated with the CSR scheme.

11. The first AP of claim 9, wherein, to communicate the plurality of frames in accordance with the joint frame transmission sequence, the processing system is configured to cause the first AP to:
transmit an initial control frame comprising a poll message of the CSR scheme, and a request for one or more wireless stations to perform a frame exchange associated with the CSR scheme and to transmit an initial coordinated response frame.

12. The first AP of claim 11, wherein, to communicate the plurality of frames in accordance with the joint frame transmission sequence, the processing system is configured to cause the first AP to:
receive, from the one or more wireless stations and based at least in part on the poll message, an initial control response frame that indicates availability of the one or more wireless stations to participate in the frame exchange associated with the CSR scheme.

13. The first AP of claim 12, wherein the processing system is further configured to cause the first AP to:
measure, based at least in part on the initial control response frame, a received signal power associated with the one or more wireless stations.

14. The first AP of claim 9, wherein, to communicate the plurality of frames in accordance with the joint frame transmission sequence, the processing system is configured to cause the first AP to:
transmit, to the second AP, a trigger frame that includes an indication of one or more of: a received signal power associated with one or more wireless stations, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

15. The first AP of claim 9, wherein, to communicate the plurality of frames in accordance with the joint frame transmission sequence, the processing system is configured to cause the first AP to:
receive, from the second AP and based at least in part on the invitation, a response frame that indicates availability of the second AP to participate in frame exchange associated with the CSR scheme.

16. A second access point (AP), comprising:
a processing system that includes processor circuitry and memory circuitry that stores code, the processing system configured to cause the second AP to:
receive, within a shared transmission opportunity of a first AP, an invite frame that indicates initiation of a joint frame transmission sequence associated with a coordinated AP scheme of a plurality of coordinated AP schemes;
communicate, within the shared transmission opportunity, a plurality of frames in accordance with the joint frame transmission sequence, the plurality of frames including information that coordinates downlink physical layer protocol data unit (PPDU) transmissions by the first AP and the second AP; and
transmit, within the shared transmission opportunity and responsive to communication of the plurality of frames, a coordinated downlink PPDU transmission.

17. The second AP of claim 16, wherein the plurality of frames comprise one or more initial control frames, one or more initial control response frames, a response frame, a trigger frame, or any combination thereof.

18. The second AP of claim 16, wherein a first coordinated AP scheme of the plurality of coordinated AP schemes comprises a CoBF scheme, and the invite frame includes an invitation to perform a coordinated beamforming (CoBF) operation between the first AP and the second AP.

19. The second AP of claim 18, wherein, to communicate the plurality of frames in accordance with the joint frame transmission sequence, the processing system is configured to cause the second AP to:
transmit, to the first AP and based at least in part on the invitation, a first initial control response frame, a response frame, or both, wherein the first initial control response frame or the response frame indicate availability of the second AP to participate in a frame exchange associated with the CoBF scheme.

20. The second AP of claim 18, wherein, to communicate the plurality of frames in accordance with the joint frame transmission sequence, the processing system is configured to cause the second AP to:
transmit an initial control frame comprising a poll message and requesting one or more wireless stations to perform a frame exchange associated with the CoBF scheme.

21. The second AP of claim 20, wherein, to communicate the plurality of frames in accordance with the joint frame transmission sequence, the processing system is configured to cause the second AP to:
receive, from the one or more wireless stations and based at least in part on the initial control frame, one or more initial control response frames that indicate availability of the one or more wireless stations to participate in the frame exchange associated with the CoBF scheme.

22. The second AP of claim 18, wherein, to communicate the plurality of frames in accordance with the joint frame transmission sequence, the processing system is configured to cause the second AP to:
receive, from the first AP, a trigger frame, wherein the trigger frame is a frequency and time synchronization reference frame, and wherein the coordinated downlink PPDU transmission is communicated in accordance with the frequency and time synchronization reference frame.

23. The second AP of claim 16, wherein a second coordinated AP scheme of the plurality of coordinated AP schemes comprises a CSR scheme, and the invite frame includes an invitation to perform a coordinated spatial reuse (CSR) operation between the first AP and the second AP.

24. The second AP of claim 23, wherein, to communicate the plurality of frames in accordance with the joint frame transmission sequence, the processing system is configured to cause the second AP to:
transmit, to the first AP and based at least in part on the invitation, a response frame that indicates availability of the second AP to participate in a frame exchange associated with the CSR scheme.

25. The second AP of claim 23, wherein, to communicate the plurality of frames in accordance with the joint frame transmission sequence, the processing system is configured to cause the second AP to:
transmit an initial control frame comprising a poll message and requesting one or more first wireless stations associated with the second AP to perform a frame exchange associated with the CSR scheme.

26. The second AP of claim 25, wherein the processing system is further configured to cause the second AP to:
monitor for an initial control response frame transmitted by the one or more first wireless stations associated with the first AP;
receive, from the one or more first wireless stations and based at least in part on the poll message, one or more initial control response frames that indicate availability of the one or more first wireless stations to participate in a frame exchange associated with the CSR scheme; and
measure, based at least in part on the one or more initial control response frames, a received signal power associated with the one or more first wireless stations.

27. The second AP of claim 26, wherein, to communicate the plurality of frames in accordance with the joint frame transmission sequence, the processing system is configured to cause the second AP to:
receive, from the first AP, a trigger frame that includes an indication of one or more of: a received signal power associated with the one or more first wireless stations, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

28. The second AP of claim 27, wherein the processing system is further configured to cause the second AP to:
adjust, based at least in part on the trigger frame, a transmit power, wherein the coordinated downlink PPDU transmission is transmitted based at least in part on the adjusted transmit power.

29. A method for wireless communication by a first access point (AP), comprising:
transmitting, within a shared transmission opportunity of the first AP, an invite frame that indicates initiation of a joint frame transmission sequence associated with a coordinated AP scheme of a plurality of coordinated AP schemes;
communicating, within the shared transmission opportunity of the first AP, a plurality of frames in accordance with the joint frame transmission sequence, the plurality of frames including information that coordinates downlink physical layer protocol data unit (PPDU) transmissions by the first AP and one or more second APs; and
transmitting, within the shared transmission opportunity of the first AP and responsive to communication of the plurality of frames, a coordinated downlink PPDU transmission.

30. A method for wireless communication by a second access point (AP), comprising:
receiving, within a shared transmission opportunity of a first AP, an invite frame that indicates initiation of a joint frame transmission sequence associated with a coordinated AP scheme of a plurality of coordinated AP schemes;
communicating, within the shared transmission opportunity, a plurality of frames in accordance with the joint frame transmission sequence, the plurality of frames including information that coordinates downlink physical layer protocol data unit (PPDU) transmissions by the first AP and the second AP; and
transmitting, within the shared transmission opportunity and responsive to communication of the plurality of frames, a coordinated downlink PPDU transmission.
